(19) United States
(12) Patent Application Publication
(10) Pub. No.: US 2003/0023960 A1
(43) Pub. Date: Jan. 30, 2003

(54) Microprocessor instruction format using combination opcodes and destination prefixes

(76) Inventors: Shoab Khan, Lahore (PK); Farrukh Kamran, Lahore (PK); Rehan Hameed, Las Flores, CA (US); Hassan Farooq, Las Flores, CA (US); Sherjil Ahmed, Irvine, CA (US)

Correspondence Address: PATENT METRIX, LLC, 14252 CULVER DR. #914, IRVINE, CA, 92604, US

(21) Appl. No.: 09/912,885

(22) Filed: Jul. 25, 2001

(51) Int. Cl. G06F 9/45

(52) U.S. Cl. 717/152

(57) ABSTRACT

The present application discloses an instruction format for storing multiple microprocessor instructions as one combined instruction. The instruction format includes a combination opcode field for storing a combination opcode that identifies a combination of the multiple instructions. The application also discloses an instruction format that uses prefix fields to specify the destination functional block for each combined instruction stored in an execute packet. A compiler program or an assembler program obtains from a table a combination opcode that corresponds to a combination of the multiple instructions. The table stores combination opcodes and their corresponding combinations of instructions. The compiler program or assembler program then assigns the found combination opcode to an opcode field of the combined instruction. In a trivial scenario, a single instruction can also be stored as a combined instruction. The compiler program or assembler program also uses prefix fields to identify the destination functional block of each combined instruction in an execute packet. A dispatcher identifies the prefix fields and sends each combined instruction in the execute packet to its destination functional block. An instruction decoder identifies the combination opcode of the combined instruction, separates the combined instruction into the multiple individual instructions, and sends each individual instruction to its respective functional unit for execution.

### BACKGROUND OF THE INVENTION

1. Field of the Invention

This invention relates to the design of computer instruction formats, and to creating, dispatching, and decoding instructions of the described formats.

2. Description of the Related Art

A number of instruction formats have been designed to accommodate microprocessor instructions of different sizes. In general, long instructions (such as 32 or 64 bits) allow for a larger number of instructions, but short instructions (such as 8 or 16 bits) save memory storage. Therefore, some instruction set architectures employ both short and long instructions as a compromise. Supporting instructions of different lengths may also be desirable for the purpose of backward compatibility. In order to support instructions of different sizes, instruction formats must be able to specify the start and end (or length) of an instruction. For example, the Pentium II instruction formats have up to six variable-length fields, five of which are optional. Using an instruction length decoder to analyze the instruction stream and to locate the start and end of an instruction, the Pentium II chip is able to support instructions of 8, 16, 32 and 64 bits in length.

Instruction formats have been designed to support the execution of multiple instructions starting at the same clock cycle. For example, the instruction format of StarCore™ (a digital signal processor core developed by Motorola and Lucent) uses a 1-bit prefix field to indicate whether the current 16-bit instruction word is the only instruction word to be executed in its cycle. If the prefix field indicates that the current word is not the only word to be executed in its cycle, then subsequent words in the instruction stream are read and analyzed until the prefix field of a subsequent word indicates the end of the cycle.

Since a single functional unit typically cannot execute multiple instructions within a clock cycle, the multiple instructions within an execute packet are usually issued to different functional units for execution. An execute packet contains one or more instructions that are to be dispatched and executed starting at the same clock cycle. Although multiple instructions (each with an opcode and any operands) may simply be included sequentially in the execute packet, doing so does not make efficient use of memory space.

### SUMMARY OF THE INVENTION

The present invention discloses an instruction format designed to support instructions of various lengths and to specify the destination functional block for each instruction within an execute packet. The instruction format also uses a combination opcode to identify the combination of multiple instructions within an execute packet, therefore saving memory space. One embodiment includes instruction formats that include fields for indicating the number of instructions contained in an execute packet, the length of each instruction, and the destination functional block for each instruction. For multiple instructions within a functional block, the opcodes can be identified as a combination opcode. A assembler or compiler creates instructions and execute packets of the described format. Instructions that will be executed starting at the same clock cycle are included in the same execute packet. A program sequencer fetches an execute packet from program memory. A dispatcher analyzes the execute packet to determine the number of instructions contained in the execute packet, the length of each instruction, and the destination functional block for each instruction. The dispatcher then sends each instruction to its corresponding destination functional block for decoding and execution. Within each functional block, an instruction decoder decodes instructions, including combined instructions identified by a combination opcode, and sends the instructions to the appropriate functional units within the functional block for execution.

### BRIEF DESCRIPTION OF THE DRAWINGS

The Detailed Description of the application is more easily understood in connection with the following drawings.

FIG. 1 is a block diagram of a digital signal processing multiprocessor.

FIG. 2 is a block diagram of a signal processing core of the multiprocessor.

FIG. 3 is a block diagram of an address generation unit.

FIG. 4 is a block diagram of the computation block.

FIG. 5 is a diagram showing one embodiment of a multi-instruction combination identified by a combination opcode.

FIG. 6A is a diagram showing one embodiment of an instruction word.

FIG. 6B is a diagram showing sample execute packets with the instruction format of FIG. 6A.

FIG. 7A is a diagram showing another embodiment of an instruction word.

FIG. 7B is a diagram showing sample execute packets with the instruction format of FIG. 7A.

FIG. 8A is a diagram showing yet another embodiment of an instruction word.

FIG. 8B is a diagram showing sample execute packets with the instruction format of FIG. 8A.

FIG. 9 illustrates one embodiment of a table that stores instruction combinations and corresponding combination opcodes.

FIG. 10 is a flowchart showing one embodiment of the process of creating an execute packet.

FIG. 11A is a flow chart showing one embodiment of the process of dispatching an execute packet with the instruction format of FIG. 6A.

FIG. 11B is a flowchart showing one embodiment of the process of dispatching an execute packet, continuing from FIG. 11A.

FIG. 12A is a flowchart showing one embodiment of the process of dispatching an execute packet with the instruction format of FIG. 7A.

FIG. 12B is a flowchart showing one embodiment of the process of dispatching an execute packet, continuing from FIG. 12A.

FIG. 13 is a flowchart showing one embodiment of the process of dispatching an execute packet with the instruction format of FIG. 8A.

FIG. 14 is a flowchart showing one embodiment of a decoding process.

FIG. 15 is a block diagram showing one embodiment of a combining module for combining individual instructions into a combined instruction.

FIG. 16 is a block diagram showing one embodiment of a decoding module for separating a combined instruction into individual instructions.

FIG. 17 is a block diagram showing one embodiment of a creation module for creating an execute packet.

FIG. 18 is a block diagram showing one embodiment of a dispatching module for dispatching an execute packet.

### DETAILED DESCRIPTION OF THE PREFERRED EMBODIMENT

This section describes embodiments of the invention with respect a digital signal processing multiprocessor. The multiprocessor is designed for digital signal processing, particularly audio signal processing. It includes a general purpose processor and a special purpose processor. The general purpose processor includes an address generation block and a computation block. Details of the multiprocessor architecture are disclosed in Appendix A. Although the architecture of the digital signal processing multiprocessor is described below for ease of illustration, the invention is not limited by the described embodiments, but defined by the claims.

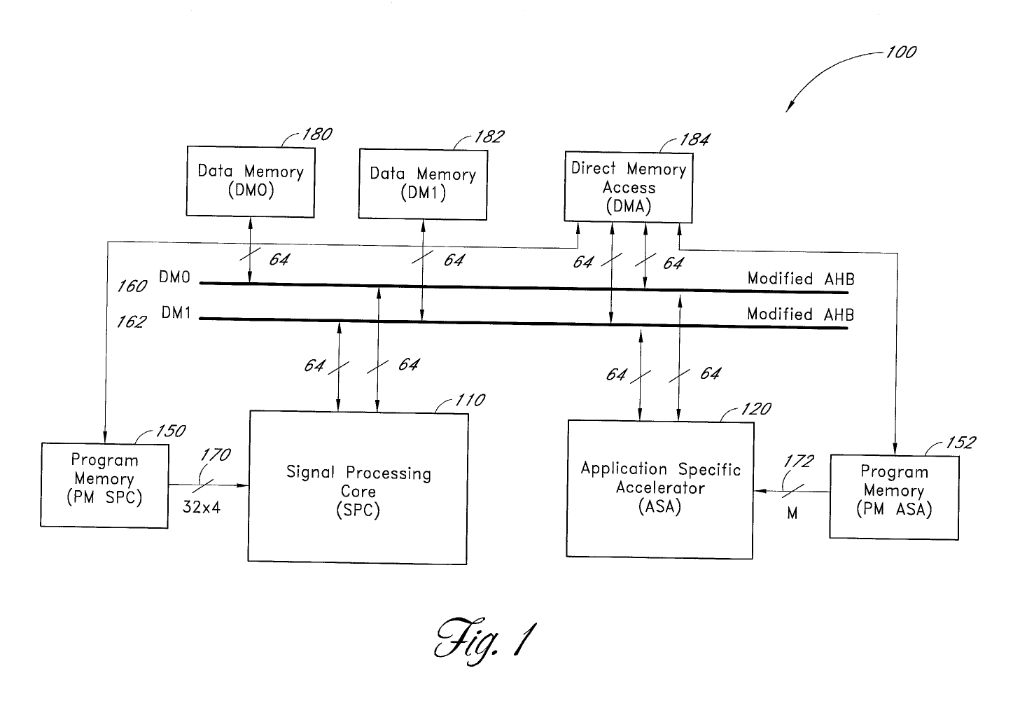

FIG. 1 is a block diagram of the multiprocessor 100. The multiprocessor 100 includes a signal processing core 110 (a general purpose processor) and an application specific accelerator 120 (a special purpose processor). In one embodiment, described in Appendix A, the application specific accelerator 120 functions as a Viterbi accelerator for modem applications. The application specific accelerator 120 can also function as a code-book search accelerator for speech applications, or any application specific accelerators.

As illustrated in FIG. 1, the signal processing core 110 is connected to a program memory 150 through a bus 170. The application specific accelerator 120 is connected to a program memory 152 through a bus 172. The signal processing core 110 and the application specific accelerator 120 are connected to a data bus 160 and a data bus 162. The data bus 160 and the data bus 162 are connected to a data memory 180 and to a data memory 182, respectively. The program memory 150, the program memory 152, the data bus 160, and the data bus 162 all connect to a direct memory access module 184.

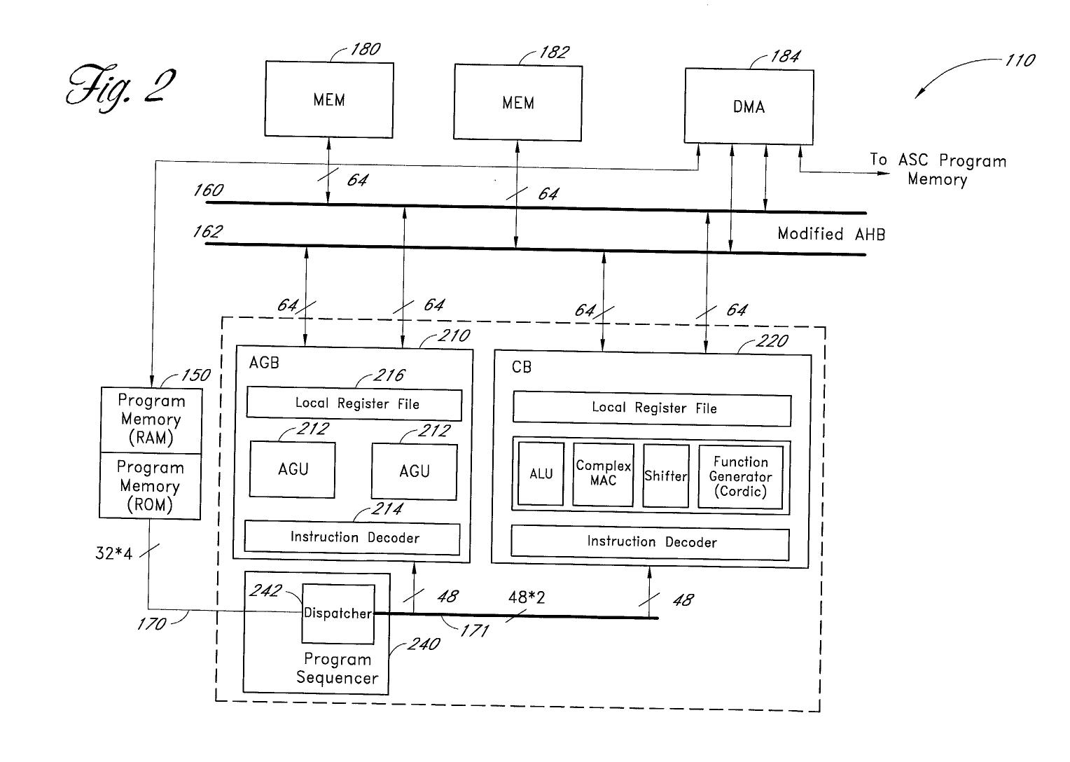

FIG. 2 is a block diagram of the signal processing core 110. The signal processing core 110 includes an address generation block (AGB) 210, a computation block (CB) 220, and a program sequencer 240, which includes a dispatcher 242.

As illustrated in FIG. 2, the program sequencer 240 includes the dispatcher 242. The program sequencer 240 fetches instructions from the program memory 150 through the bus 170. The dispatcher 242 dispatches instructions through the bus 171 to appropriate functional blocks (such as the address generation block 210 or the computation block 220) for execution. The program sequencer 240 also handles changes in program flow caused by branches, loops, interrupts and so forth.

The address generation block 210 includes one or more address generation units. As illustrated in FIG. 2, the address generation block 210 includes two address generation units 212. The two address generation units share an instruction decoder 214, a local register file 216 and one or more status registers (not shown). For more details of the address generation block 210, refer to Appendix A.

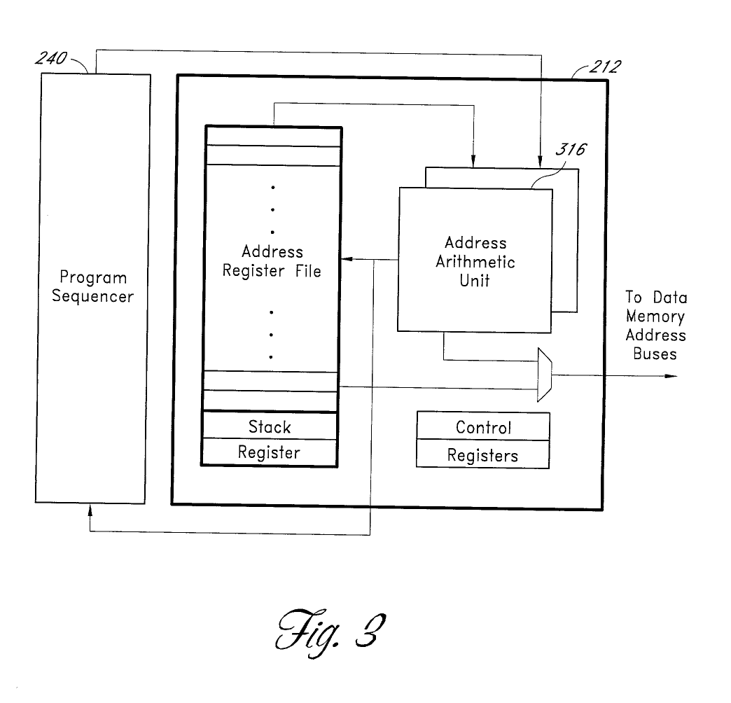

FIG. 3 is a block diagram of the address generation units 212. As illustrated in FIG. 3, each address generation unit 212 has its own address arithmetic unit 316 for address calculation. Address generation unit instructions include data transfer instructions and change of flow instructions. For descriptions of sample address generation unit instructions, refer to Appendix A.

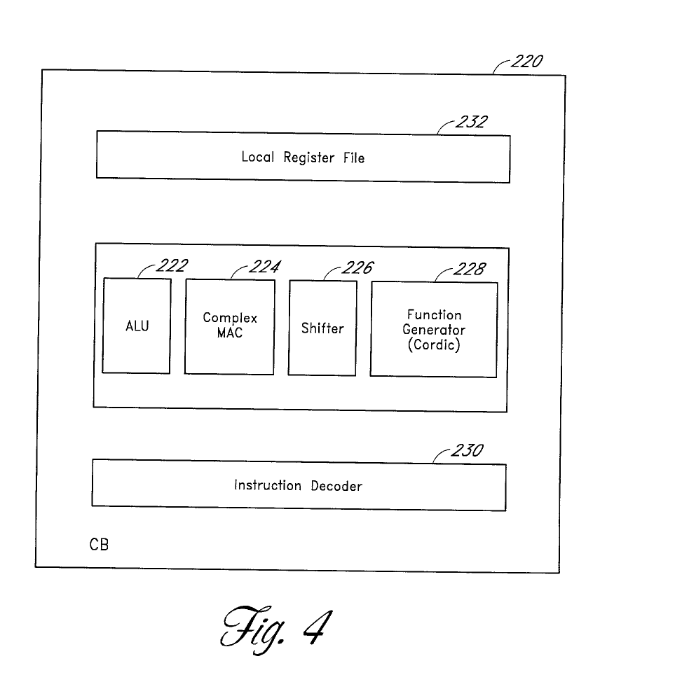

FIG. 4 is a block diagram of the computation block 220. The computation block 220 includes an ALU (Arithmetic Logic Unit) 222, a complex MAC (Multiple and Accumulate) unit 224, a Shifter unit 226, and a Function Generator unit 228. The computation block 220 also includes an instruction decoder 230 and a local register file 232. For more details of the computation block 220 and for descriptions of sample computation block instructions, refer to Appendix A.

Multiple instructions can be combined into one instruction, using a combination opcode to save memory space. For example, assume that a given processor has two functional units: a ALU unit and a MAC unit. Further assume that there are 30 ALU (Arithmetic Logic Unit) instructions and 2 MAC (Multiply and Accumulate) instructions for the ALU unit and the MAC unit respectively. Since two instructions for the same functional unit cannot be executed in the same cycle, there are only 60 (30*2) possible 2-instruction combinations. Therefore there are only 92 (30+2+60) possible instructions or instruction combinations, and a 7-bit combination opcode (2⁷=128) would be sufficient to describe all 92 possibilities. Each 2-instruction execute packet may then be described by a 7-bit combination opcode, followed by the operands of each of the two instructions. However, if two instructions are included sequentially in the execute packet without using a combination opcode, then each instruction opcode needs a 5-bit field (since each opcode can be one of 32 opcodes), and the two opcodes need a total of 10 bits of memory space, more than the 7-bit combination opcode.

The advantage of a combination opcode is described below in a more formal fashion. In one embodiment, there are a total of three functional units denoted Unit A, Unit B, and Unit C (such as an ALU unit, a MAC unit, and a shifter). Unit A is capable of executing instructions A1, A2, . . . Ai, Unit B is capable of executing instructions B1, B2, . . . Bj, and Unit C is capable of executing instructions C1, C2, . . . Ck. Therefore, there are a total number of (i+j+k) instruction opcodes, a minimum space of log₂ (i+j+k) is needed to store an instruction opcode.

Using a conventional format in which instructions are stored sequentially in an execute packet without combination opcodes, in order to store the two opcodes of a two-instruction group, a minimum space 2log₂ (i+j+k) must be allocated (because each opcode may be one of (i+j+k) opcodes). In order to store the three opcodes of a three-instruction group of a Unit A, a Unit B and a Unit C instruction, a minimum space of 3log₂ (i+j+k) must be allocated.

The combining process uses a combination opcode for each combination of instructions of different functional units. Since multiple instructions cannot be executed by the same functional unit within a cycle, the process assigns combination opcodes only to combinations of instructions issued to different functional units, therefore saving memory space.

Using the above-described scenario where three functional units A, B, and C have instructions A1-Ai, B1-Bj and C1-Ck, a combination opcode is assigned to each of the following combinations:

A1B1, A1B2, . . . A1Bj,

A2B1, A2B2, . . . A2Bj,

. . .

AiB1, AiB2, . . . AiBj,

/* the above are Unit A and Unit B instruction combinations */

A1C1, A1C2, . . . A1Ck,

A2C1, A2C2, . . . A2Ck,

. . .

AiC1, AiC2, . . . AiCk,

/* the above are Unit A and Unit C instruction combinations */

B1C1, B1C2, . . . B1Ck,

B2C1, B2C2, . . . B2Ck,

. . .

BjC1, BiC2, . . . BiCk,

/* the above are Unit B and Unit C instruction combinations */

A1B1C1, A1B1C2, . . . A1B1Ck,

A1B2C1, A1B2C2, . . . A1B2Ck,

. . .

A1BjC1, A1BjC2, . . . A1BjCk,

A2B1C1, A2B1C2, . . . A2B1Ck,

A2B2C1, A2B2C2, . . . A2B2Ck,

. . .

A2BjC1, A2BjC2, . . . A2BjCk,

. . .

AiB1C1, AiB1C2, . . . AiB1Ck,

AiB2C1, AiB2C2, . . . AiB2Ck,

. . .

AiBjC1, AiBjC2, . . . AiBjCk.

/* the above are Unit A, Unit B and Unit C instruction combinations */

By using a combination opcode to identify the multiple-instruction combination, memory space can be saved. As illustrated above, there are (i+j+k) possible single instructions, (i*j) possible 2-instruction combinations of a Unit An instruction and a Unit B instruction (A-B combinations), (i*k) possible A-C combinations, (j*k) possible B-C combinations, and (i*j*k) possible 3-instruction combinations. Therefore, only a minimum space of log₂ (i+j+k+i*j+i*k+j*k+i*j*k) is required to store a combination opcode that is capable of describing any instruction or instruction combination. This space requirement is less than the space requirement of 3log₂ (i+j+k) for conventional formats. Those ordinarily skilled in the art would appreciate that log₂ (i+j+k+i*j+i*k+j*k+i*j*k) is less than 3log₂ (i+j+k),because(i+j+k+i*j+i*k+j*k+i*j*k)<(i+j+k)³. In fact, when X₁, X₂, . . . and Xₙ are positive integers, for any n>1, the formula

X₁+X₂+ . . . +Xₙ+X₁*X₂+ . . . +Xₙ₋₁*Xₙ+ . . . +X₁*X₂* . . . *Xₙ<(X₁+X₂+ . . . +Xₙ)ⁿ

is always true.

In one embodiment in which there are multiple functional blocks each with its own instruction decoder, an instruction for a functional unit in one functional block is not combined with an instruction for a functional unit in another functional block. For example, an instruction for a functional unit in the address generation block 210 is not combined with an instruction for a functional unit in the computation block 220. Therefore, such instruction combinations need not be considered and need not be assigned combination opcodes. As a result, the number of instruction combinations is further reduced, further saving memory space.

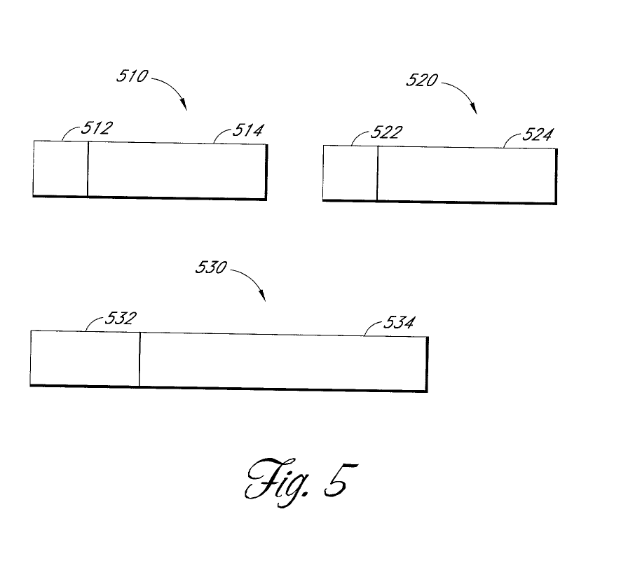

FIG. 5 is a diagram showing one embodiment of a multi-instruction combination identified by a combination opcode. An individual instruction 510 includes an opcode field 512 and an operand field 514. An individual instruction 520 includes an opcode field 522 and an operand field 524. The instruction 510 and the instruction 520 are to be executed by different functional units within a functional block. The instructions 510 and 520 are combined into a combined instruction 530, which includes a combination opcode field 532 and a combined operand field 534. As described above, the combination opcode field 532 is shorter in length than the total length of the opcode fields 512 and 522. The combined operand field 534 stores the operands of the operand fields 514 and 524. In one embodiment, a prefix is included in the combined instruction 530, for example to indicate the length of the operand(s) of the instruction 510 in the combined operand field 534, or to indicate the starting position of operand(s) of the instruction 520 in the combined operand field 534. The prefix is added in order to distinguish the operand(s) of instruction 510 from the operand(s) of instruction 520 in the combined operand field 534. In another embodiment, no prefix is included, because by identifying the combination opcode and thus the individual instructions, an instruction decoder in the functional block is able to infer the length of the operand(s) of the instruction 510 and the instruction 520.

The term “individual instruction” refers to an instruction that can be executed by one functional unit (such as an ALU unit 222 or an address Generation Unit 212) in the instruction's original form. The term “individual opcode” refers to an opcode that can be recognized by one functional unit in its original form. The term “instruction”, as used in the Specification, refers to individual instructions as well as combinations of individual instructions. Although individual instructions within an execute packet are typically executed starting at the same clock cycle, their execution do not always complete within the same cycle, because some individual instructions require two or more clock cycles for execution. In one embodiment of the multiprocessor architecture, instructions of all functional units are single-cycle instructions, except some instructions for the function generator unit 228. In one embodiment, only single-cycle instructions (i.e., instructions whose execution complete in one cycle) are combined within an execute packet, and multiple-cycle function generator unit 228 instructions are not combined with other instructions within an execute packet.

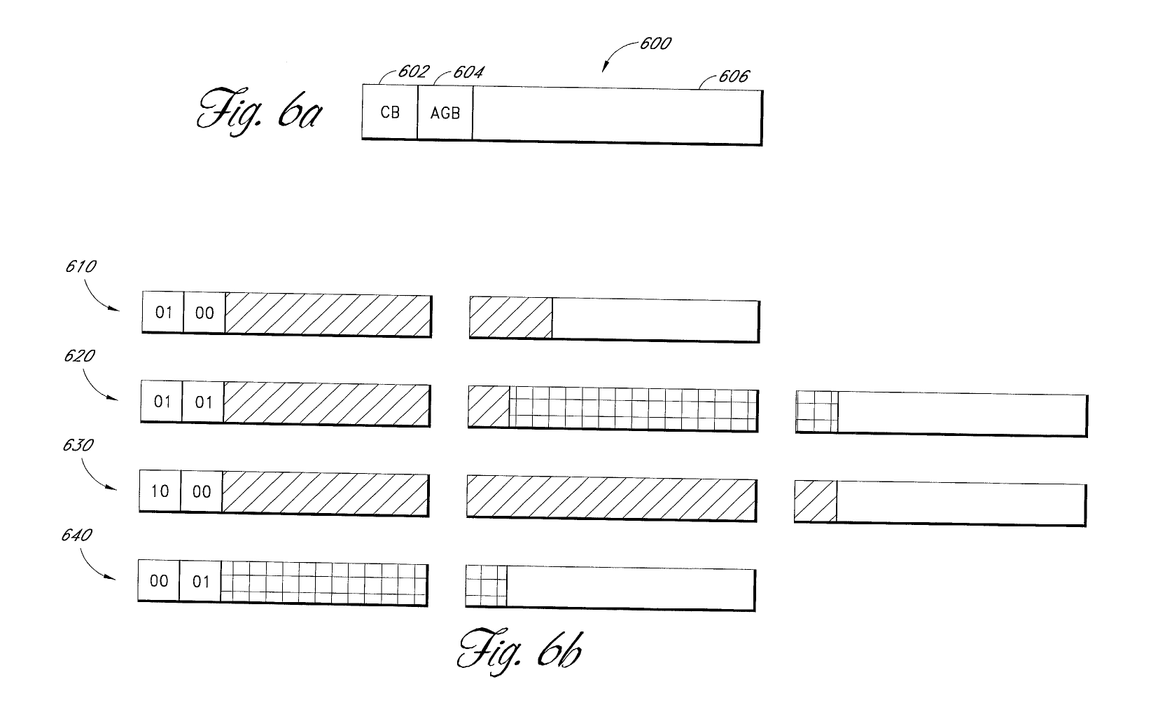

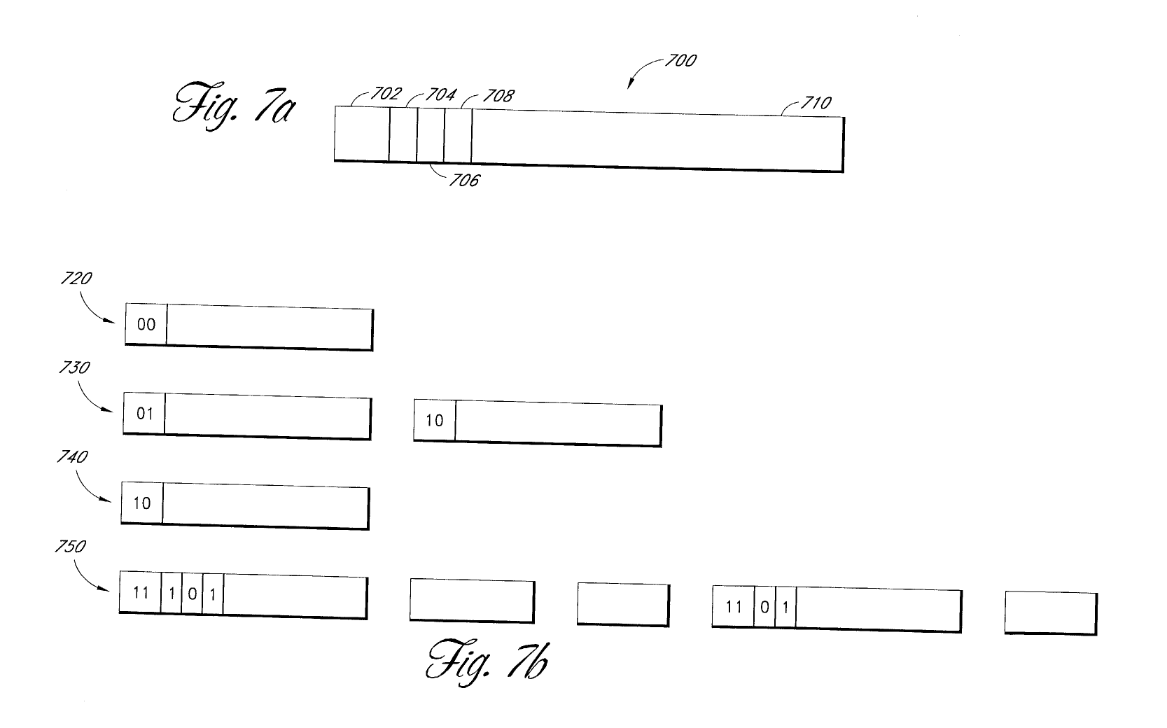

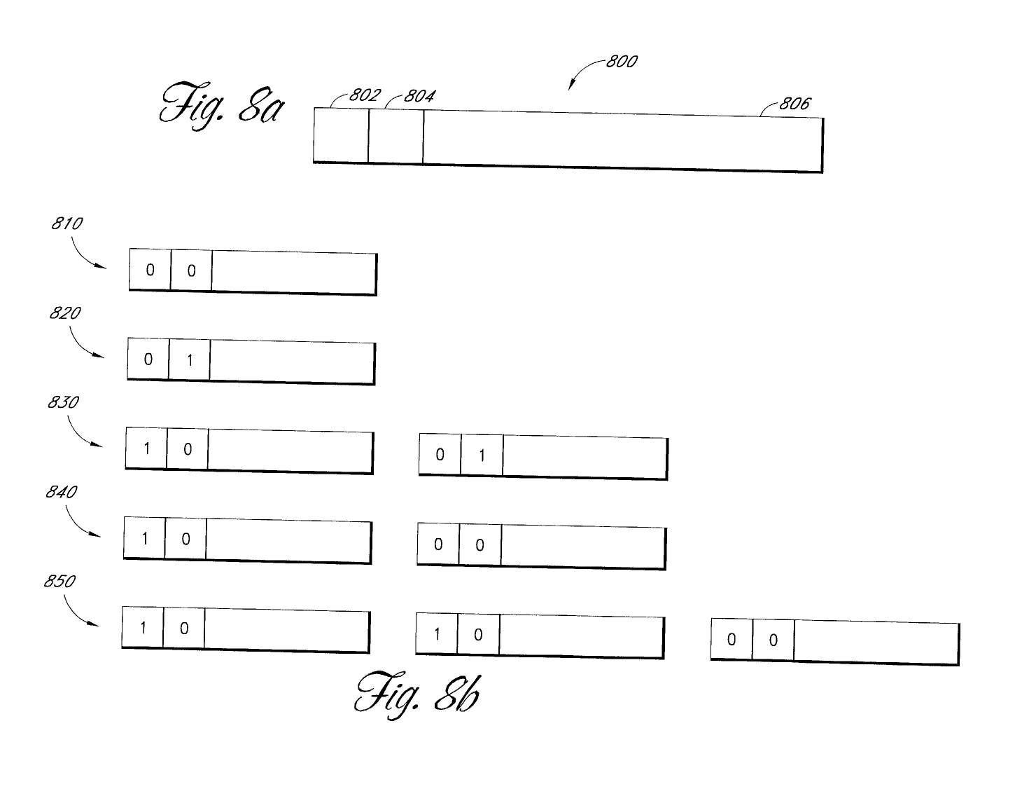

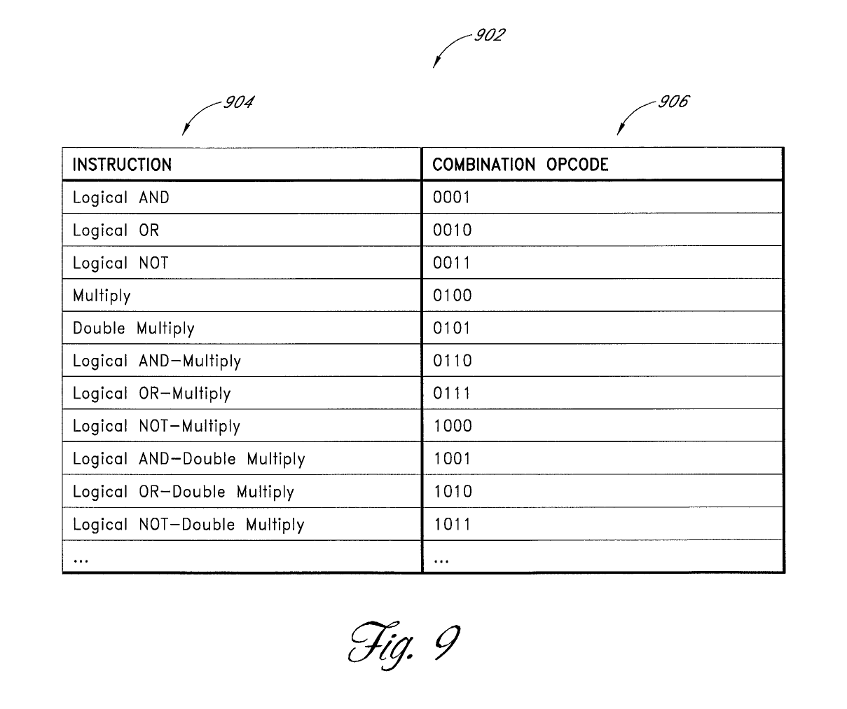

A number of instruction format embodiments can be used to specify the number of instructions in an execute packet, to specify the start and end (or length) of each instruction, and to specify the destination functional block for each instruction. Three example embodiments are described below in connection with FIG. 6A, FIG. 7A, and FIG. 8A. The term “instruction” is used in these embodiments to describe a computation block instruction or an address generation block instruction, which can be a combination of multiple instructions sharing the same destination functional block. The term “actual instruction” is used to refer to an instruction without the prefix fields described in the FIG. 6A, FIG. 7A and FIG. 8A embodiments.

FIG. 6A is a diagram showing one embodiment of a 16-bit instruction word 600. The instruction word 600 includes an optional first prefix field 602 that indicates the length of the computation block instruction in the current execute packet. The instruction word 600 also includes an optional second prefix field 604 that indicates the length of the address generation block instruction in the current execute packet. In the case in which the instruction field does not include a computation block instruction or an address generation block instruction, then the first prefix field 602 or the second prefix field 604 indicates a length of zero respectively. In one embodiment, the prefix fields 602 and 604 are both 2-bit fields, making a total prefix area of 4 bits. Each of the 2-bit binary prefix fields is capable of indicating 4 possible values (00, 01, 10, 11) that correspond to instruction lengths of 0, 16, 32 and 48 bits respectively. If required to support multiple computation blocks and/or multiple address generation blocks, the prefix area can be expanded to include a prefix field for each of the computation blocks and each of the address generation blocks.

The instruction word 600 also includes an instruction field 606, which is 12 bits (if the word 600 also includes the optional prefix fields 602 and 604) or 16 bits in length (if the word 600 does not include the optional prefix fields 602 and 604). The instruction field 606 stores an actual instruction or part of an actual instruction. The word 600 includes the prefix fields 602 and 604 only if the word 600 is the first word in the execute packet.

FIG. 6B is a diagram showing sample execute packets 610, 620, 630 and 640 having the format described in FIG. 6A. Each case (610, 620, 630, 640) represents an execute packet, with each rectangle block representing a 16-bit word. In the packet 610, the prefix fields 602 and 604 have respective values of 01 and 00, indicating a 16-bit actual instruction for the computation block 220. The 16-bit actual instruction occupies the 12-bit instruction field of the first word and the first 4 bits of the 16-bit instruction field of the second word. In the packet 620, the prefix fields 602 and 604 both have the value 01, indicating a 16-bit computation block actual instruction and a 16-bit address generation block actual instruction. The first 16-bit actual instruction occupies the last 12 bits of the first word and the first 4 bits of the second word. The second 16-bit actual instruction occupies the last 12 bits of the second word and the first 4 bits of the third word. In the packet 630, the prefix fields 602 and 604 have respective values of 10 and 00, indicating a 32-bit computation block actual instruction. The 32-bit actual instruction occupies the last 12 bits of the first word, the 16 bits of the second word, and the first 4 bits of the third word. In the packet 640, the prefix fields 602 and 604 have respective values of 00 and 01, indicating a 16-bit address generation block actual instruction. The 16-bit actual instruction occupies the 12-bit instruction field of the first word and the first 4 bits of the 16-bit instruction field of the second word.

FIG. 7A is a diagram showing another embodiment of a 16-bit instruction word 700. The instruction word 700 includes an instruction field 710 which stores an actual instruction or part of an actual instruction. The instruction word 700 also includes an optional 2-bit first prefix field 702, an optional 1-bit second prefix field 704, an optional 1-bit third prefix field 706, and an optional 1-bit fourth prefix field 708. As will be described later, the instruction word 700 includes the 2-bit optional first prefix field 706 only if the current word 700 is the first word in a 16, 32 or 48 bit instruction unit. The instruction word 700 includes the 1-bit optional prefix fields 704, 706 and 708 only if the value of the first prefix field 702 is 11.

As described below, using this format, an instruction can have an actual length of 14 bits, 27 bits, or 43 bits, but the phrases “16-bit instruction unit”, “32-bit instruction unit” and “48-bit instruction unit” are also used for ease of description, to represent the instructions with actual length of 14, 27 and 43 bits, with additional prefix areas of 2 bits, 5 bits, and 5 bits respectively. A 16-bit instruction unit includes the 2-bit first prefix field 702 followed by a 14-bit instruction field 710. A 32-bit instruction unit includes a 16-bit word having the prefix fields 702, 704, 706 and 708 and a 11-bit instruction field 710, and another 16-bit word having no prefix fields and a 16-bit instruction field. Therefore a 32-bit instruction unit can store an instruction of 27 bits (11+16). A 48-bit instruction unit consists of a 16-bit word having the prefix fields 702, 704, 706 and 708 and a 11-bit instruction field 710, and two 16-bit words each with a 16-bit instruction field. Therefore a 48-bit instruction unit can store an instruction of 43 bits (11+16+16). As described above, a 27 or 43 bit instruction may in fact be a combination of multiple instructions sharing the same destination functional block. A 14-bit instruction may also be a combination of two short instructions sharing the same destination functional block.

Since the first binary prefix field 702 is 2 bits in length, it is capable of indicating the following 4 possibilities:

00 indicates that the current execute packet is one 16-bit instruction unit having a computation block instruction;

01 indicates that the current execute packet has one 16-bit instruction unit having a computation block instruction, followed by another instruction unit having an address generation block instruction;

10 indicates that the current word is a 16-bit instruction unit having an address generation block instruction, and is the last word in the execute packet; and

11 indicates that the current word in the current execute packet is not a 16-bit instruction unit.

The prefix values 00, 01, 10 and 11 refer to binary numbers. When the value of the first prefix field 702 is 11, the dispatcher 242 reads the second prefix field 704, which is 1 bit in length and capable of indicating the following 2 possibilities:

0 indicates that the current instruction unit is a 32-bit instruction unit; and

1 indicates that the current instruction unit is a 48-bit instruction unit.

When the value of the first prefix field 702 is 11, the dispatcher 242 also reads the third prefix field 706, which is 1 bit in length and capable of indicating the following 2 possibilities:

0 indicates that the instruction in the 32 or 48 bit instruction unit is a computation block instruction; and

1 indicates that the instruction in the 32 or 48 bit instruction unit is an address generation block instruction.

When the value of the first prefix field 702 is 11 and the value of the third prefix field 706 is 0, the dispatcher 242 reads the fourth prefix field 708, which is 1 bit in length and capable of indicating the following 2 possibilities:

0 indicates that the 32 or 48 bit instruction unit having a computation block instruction is the only instruction unit in the execute packet; and

1 indicates that the 32 or 48 bit instruction unit having a computation block instruction is followed by an instruction unit having an address generation block instruction.

When the first prefix field 702 is not 11, the optional prefix fields 704, 706 and 708 are omitted and become part of the instruction field 710. Therefore, a 16-bit word 600 has a 14-bit instruction field 710. When the first prefix field 702 is 11, the optional prefix fields 704, 706 and 708 are not omitted. Since the entire prefix area is now 5 bits in length (having the 2-bit first prefix field 702, and the 1-bit prefix fields 704, 706 and 708), a 32-bit word 700 has a 27-bit instruction field 710, and a 48-bit word 700 has a 43-bit instruction field 710.

In another embodiment, when the value of the first prefix field 702 is 11 and the value of the third prefix field 706 is 1 (indicating a 32 or 48 bit instruction unit having an address generation block instruction), the optional fourth prefix field 708 is omitted and this 1-bit field becomes part of the instruction field 710. This is because an address generation block instruction will not be followed by a computation block instruction in the described embodiments. Therefore a 32-bit or 48-bit instruction unit having an address generation block instruction may have a actual instruction length of 28 or 44 bits, instead of the above-described 27 or 43 bits.

FIG. 7B is a diagram showing sample execute packets 720, 730, 740, and 750, having the format described in FIG. 7A. Each case (720, 730, 740, 750) represents an execute packet, with each rectangle block representing a 16-bit word. In the packet 720, the first prefix field 702 has a value 00, and the dispatcher 242 recognizes that the current execute packet has only a 16-bit instruction unit having a 14-bit computation block instruction. In the packet 730, the first prefix field 702 has a value 01, and the dispatcher 242 recognizes that the execute packet has a 16-bit instruction unit having a 14-bit computation block instruction followed by a second instruction unit having a 14-bit address generation block instruction, and that the second instruction unit starts at the 17^{th} bit of the execute packet. Since the first prefix field 702 of the second instruction unit has a value 10, the dispatcher 242 recognizes a 16-bit instruction unit having an address generation block instruction, and being the last word in the current execute packet.

In the packet 740, the first prefix field 702 has a value 10, the dispatcher 242 recognizes that the current word is a 16-bit instruction unit having an address generation block instruction, and that it is the last word in the current execute packet. In the packet 750, the first prefix field 702 has a value 11, the dispatcher 242 recognizes that the current instruction unit is a 32-bit or 48-bit instruction unit. The dispatcher 242 then reads the 1-bit prefix fields 704, 706 and 708, which have respective values 1, 0, and 1. The dispatcher 242 therefore recognizes that the current instruction unit is a 48-bit instruction unit having a 43-bit computation block instruction, and that the current 48-bit instruction unit is followed by another instruction unit having an address generation block instruction. Therefore, the dispatcher recognizes the second and third words of the packet 750 as 16-bit instruction fields without prefix fields. The dispatcher reads the prefix fields of the fourth word in the packet 750 and recognizes a 32-bit instruction unit having a 27-bit (or 28-bit, if the fourth prefix field 708 is omitted) address generation block instruction.

As those of ordinarily skill in the art will appreciate, the prefix fields 702, 704, 706 and 708 can be combined or separated into more or fewer prefix fields of longer or shorter length, in order to indicate the number and length of instruction units in an execute packet, and to indicate whether each instruction unit includes a computation block instruction or an address generation block instruction.

FIG. 8A is a diagram showing yet another embodiment of a 16-bit instruction word 800. The instruction word 800 includes a 14-bit instruction field 806 which stores the actual instruction or a part of the actual instruction. The instruction word 800 also includes a first prefix field 802 and a second prefix field 804. The first prefix field is 1 bit in length and indicates the following 2 possibilities:

0 indicates that the current execute packet has a single 16-bit instruction word; and

1 indicates that the next 16-bit word is also part of the current execute packet.

The second prefix field is 1 bit in length and indicates the following 2 possibilities:

0 indicates that the instruction in the instruction field 806 is a computation block instruction; and

1 indicates that the instruction in the instruction field 806 is an address generation block instruction.

FIG. 8B is a diagram showing sample execute packets 810, 820, 830, 840 and 850 having the format described in FIG. 8A. In FIG. 8B, each case (810, 820, 830, 840, 850) represents an execute packet, each rectangle block represents a 16-bit word. In the packet 810, the first prefix field 802 has a value 0 and the second prefix field 804 has a value 0, and the dispatcher 242 recognizes the execute packet as having a single 16-bit word having a computation block instruction. In the packet 820, the first prefix field 802 has a value 0 and the second prefix field 804 has a value 1, and the dispatcher 242 recognizes the execute packet as a single 16-bit word having an address generation block instruction. In the packet 830, the first prefix field 802 has a value 1 and the second prefix field 804 has a value 0, and the dispatcher 242 recognizes that the first word's instruction is to be dispatched to the computation block 220, and that the next 16-bit word is also part of the current execute packet. The first and second prefix fields of the second 16-bit word have respective values of 0 and 1, indicating the end of the current execute packet and that the instruction of the second word is to be dispatched to the address generation block 210.

In the packet 840 of FIG. 8B, the prefix fields of the first word has the same value combination as the prefix fields of the first word in the packet 830, but the prefix fields of the second word have respective values 0 and 0, indicating that the instruction in the second word is to be dispatched to the computation block 220. Therefore, a 28-bit actual instruction is in fact dispatched to the computation block 220. In the packet 850, which is an expansion of the packet 840, the prefix fields of the first 16-bit word indicate that the first instruction is to be dispatched to the computation block 220, followed by another instruction in the execute packet. The prefix fields of the second 16-bit word indicate that the first instruction in the second word is to be dispatched to the computation block 220, followed by another instruction in the execute packet. The prefix fields of the third 16-bit word indicate the end of the execute packet. Therefore, a 42-bit actual instruction is dispatched to the computation block 220.

As those of ordinary skill in the art will appreciate, the prefix fields 802 and 804 can be combined or separated into more or fewer prefix fields of longer or shorter length, in order to indicate the number of instructions words in the current execute packet, and to indicate the destination of each instruction (e.g., computation block or address generation block.

FIG. 9 is a diagram showing one embodiment of a table 902 that lists instruction combinations and their corresponding combination opcodes. In the table 902, for each individual instruction or combination of individual instructions in the an “INSTRUCTION” field 904, a combination opcode in a “COMBINATION OPCODE” field 906 is used to described the instruction or instruction combination. As illustrated in FIG. 9, the field 904 stores the identification for the ALU unit 222 instructions “Logical AND”, “Logical OR” and “Logical NOT”, the identification for the complex MAC unit 224 instructions “Multiply” and “Double Multiply”, and the identification for combinations of the ALU unit 222 and the complex MAC unit 224 instructions. The field 906 stores the corresponding combination opcodes in binary form. For an individual instruction, its individual opcode can be stored as its combination opcode. Although the field 904 stores the name of an individual instruction or instruction combination as identification, the individual opcode of the individual instruction or the opcode combination of the instruction combination is used in one embodiment for identification.

In one embodiment, the table 902 only stores combination opcodes for combinations of individual instructions. In another embodiment (such as the table 902 illustrated in FIG. 9), opcodes for individual instructions are also stored as “combination opcodes” in the table 902.

In one embodiment, the combination opcodes of field 906 are of uniform length. In another embodiment, the combination opcodes of frequently used individual instructions or instruction combinations are assigned shorter lengths, while combinations opcodes of less frequently used individual instructions or instruction combinations are assigned longer lengths. Such an arrangement can further reduce memory space, because the shorter length combination opcodes are thereby used more frequently.

Since multiple instructions cannot be executed by the same functional unit within a clock cycle, table 902 need not store combinations of instructions for the same functional unit. Therefore, table 902 need not store instruction combinations such as “Logic AND-Logic OR” or “Multiply-Double Multiply”. In one embodiment, illustrated in FIG. 2, since instructions are first sent to their destination functional blocks and then decoded by an instruction decoder 214 or 230, table 902 need not list combinations of instructions for different functional blocks. For example, table 902 need not list combinations of an address Generation Unit instruction and a ALU unit instruction, because an address Generation Unit 212 and a ALU unit 222 are located in different functional blocks and use different instruction decoders. In another embodiment in which all functional units are located within the same functional block (thus making it redundant to refer to a “functional block”), table 902 stores combinations of instructions for all different functional units.

As used herein, the term “table” is not limited to any particular data structure such as a relational table, an object table, and so forth. The term “table” is used broadly to include any computer-readable form of storing correspondences of combination opcodes and instruction combinations. For example, table 902 can be implemented as a series of logical conditions. The following pseudo-code illustrates as example one implementation of table 902.

If instr_{—}1=“Logical AND” and instr_{—}2=“” then comb_opcode=“0001”

Else if instr_{—}1=“Logical OR” and instr_{—}2=“” then comb_opcode=“0010”

Else if instr_{—}1=“Logical NOT” and instr_{—}2=“” then comb_opcode=“0011”

Else if instr_{—}1=“Multiply” and instr_{—}2=“” then comb_opcode=“0100”

Else if instr_{—}1=“Double Multiply” and instr_{—}2=“” then comb_opcode=“0101”

Else if instr_{—}1=“Logical AND” and instr_{—}2=“Multiply” then comb_opcode=“0110”

Else if instr_{—}1=“Logical OR” and instr_{—}2=“Multiply” then comb_opcode=“0111”

Else if instr_{—}1=“Logical NOT” and instr_{—}2=“Multiply” then comb_opcode=“1000”

Else if instr_{—}1=“Logical AND” and instr_{—}2=“Double Multiply” then comb_opcode=“1001”

Else if instr_{—}1=“Logical OR” and instr_{—}2=“Double Multiply” then comb_opcode=“1010”

Else if instr_{—}1=“Logical NOT” and instr_{—}2=“Double Multiply” then comb_opcode=“1011”

. . .

Execute packets are created by a compiler or an assembler and stored in program memory 150, to be fetched by the program sequencer 240 and dispatched by the dispatcher 242. Referring back to FIG. 5 for an example of combining two individual instructions 510 and 520, a compiler or assembler program retrieves from the table 902 a combination opcode that corresponds to the combination of a first opcode and a second opcode, the first opcode and the second opcode being the opcodes stored in the field 512 and the field 522. The compiler or assembler program then stores the retrieved combination opcode in the combination opcode field 532 of the combined instruction 530. The assembler or compiler program also stores the operands in the operand fields 514 and 524 in the combined operand field 534. In one embodiment, the assembler or compiler program stores an additional prefix value in the combined instruction 530, in order to distinguish the operand(s) of instruction 510 from the operand(s) of instruction 520.

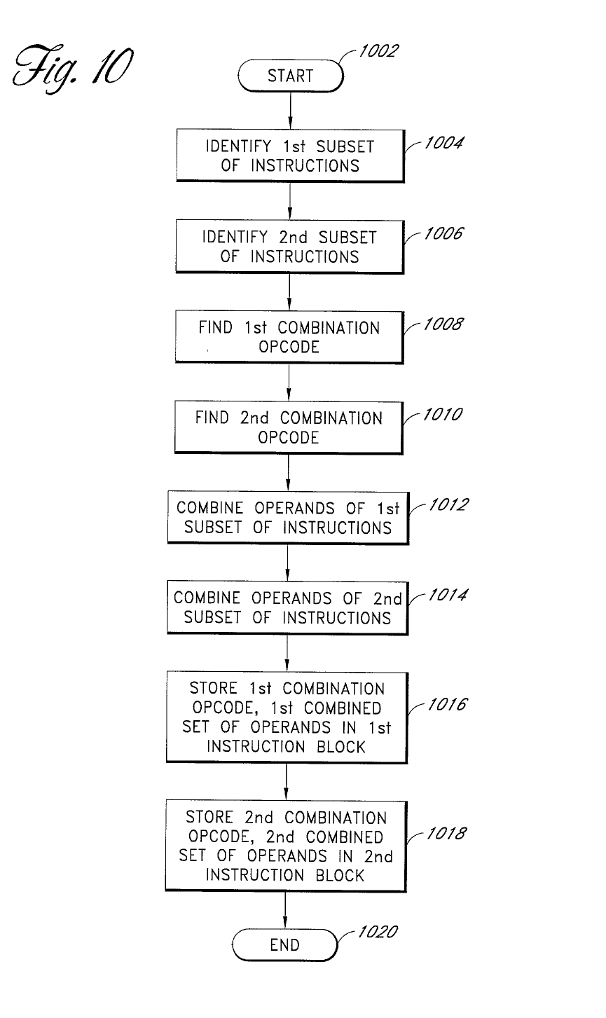

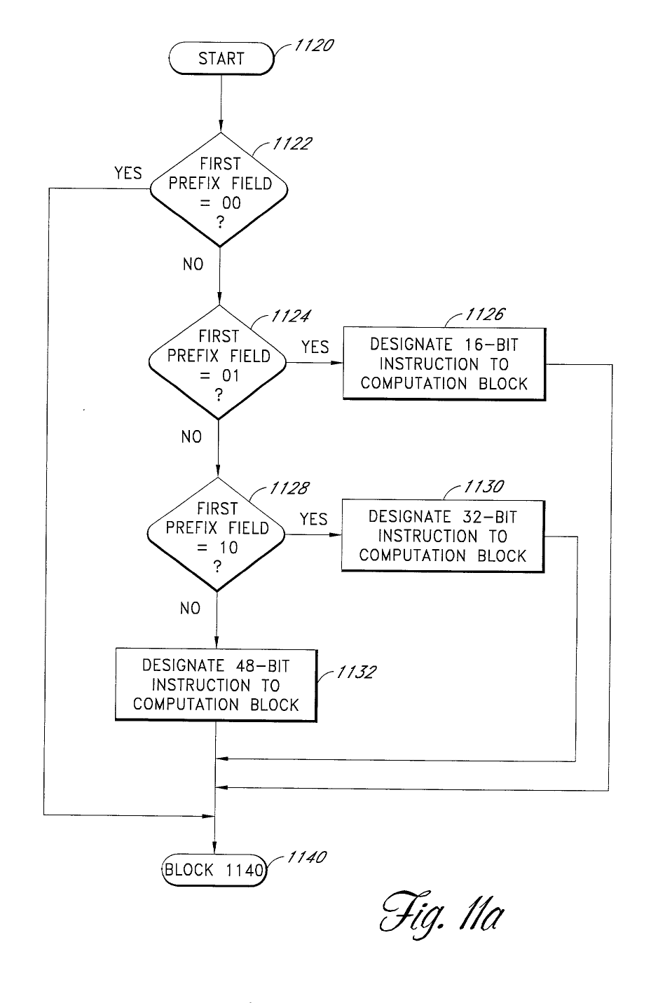

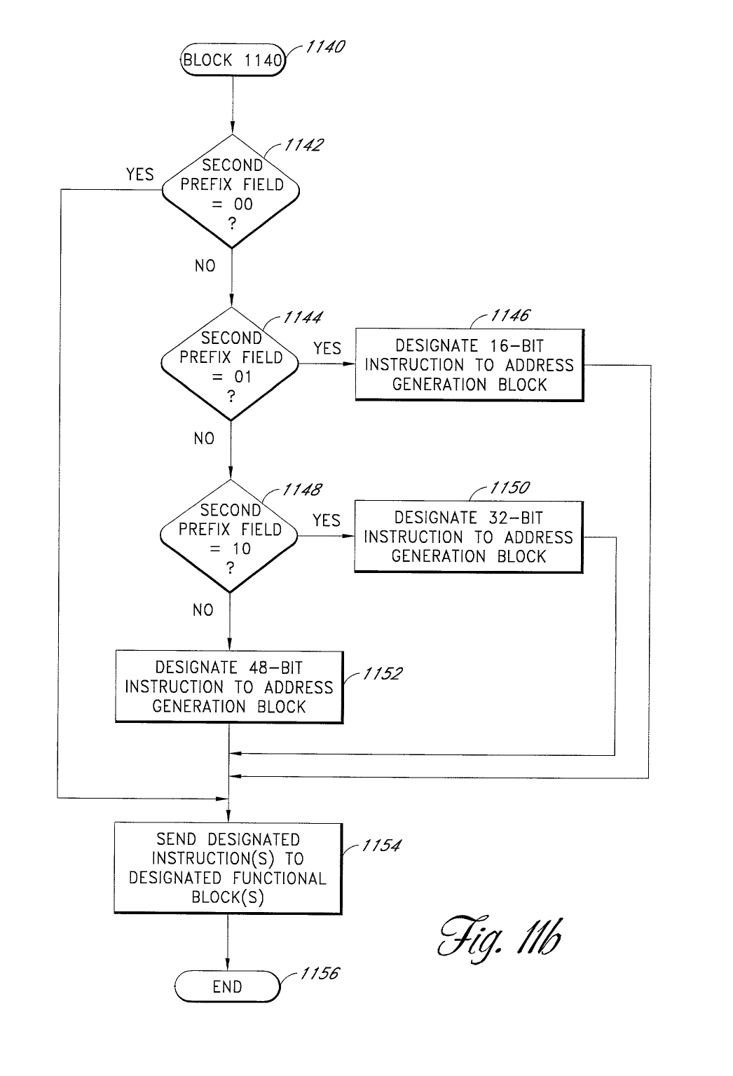

FIG. 10 is a flowchart showing one embodiment of the process of creating an execute packet. From a start block 1002, the process then proceeds to a block 1004. At the block 1004, from a set of instructions to be executed starting at the same clock cycle, an assembler or a compiler program identifies a first subset of instructions that share the destination of a first functional block. The process proceeds to a block 1006. At the block 1006, the program identifies a second subset of instructions that share the destination of a second functional block. In one embodiment where there are more than two functional blocks, the program identifies a subset for instructions of each destination functional block. The process then proceeds to a block 1008. At the block 1008, from the table 902, the program obtains a first combination opcode for the combination of the first subset of instructions. The process proceeds to a block 1010. At the block 1010, the program obtains a second combination opcode for the combination of the second subset of instructions. The process then proceeds to a block 1012.

At the block 1012, the program combines the operands of the first subset of instructions into a first combined set of operands. In one embodiment, the process appends the operands of every other instruction in the subset to the operands of the first instruction in the subset. The process then proceeds to a block 1014. At the block 1014, the program combines the operands of the second subset of instructions into a second combined set of operands. The process then proceeds to a block 1016. At the block 1016, the program stores the first combination opcode and the first combined set of operands in a first instruction block of the execute packet. The process then proceeds to a block 1018. At the block 1018, the program stores the second combination opcode and the second combined set of operands in a second instruction block of the execute packet. In one embodiment where there are more than two functional blocks, the program stores a combination opcode and a combined set of operands in an instruction block for each functional block. The process proceeds from the block 1018 to an end block 1020.

In embodiments described in connection with FIGS. 6A, 7A, and 8A, prefix fields such as field 602 and field 604 for FIG. 6A, field 702, 704, 706 and 708 for FIG. 7A, and field 802 and field 804 for FIG. 8A are added to the execute packet. For example, if the instruction format of FIG. 6A is used, the program stores a first prefix field 602 and a second prefix field 604 in the execute packet. The first prefix field 602 indicates the length of the first instruction block, the second prefix field 604 indicates the length of the second instruction block.

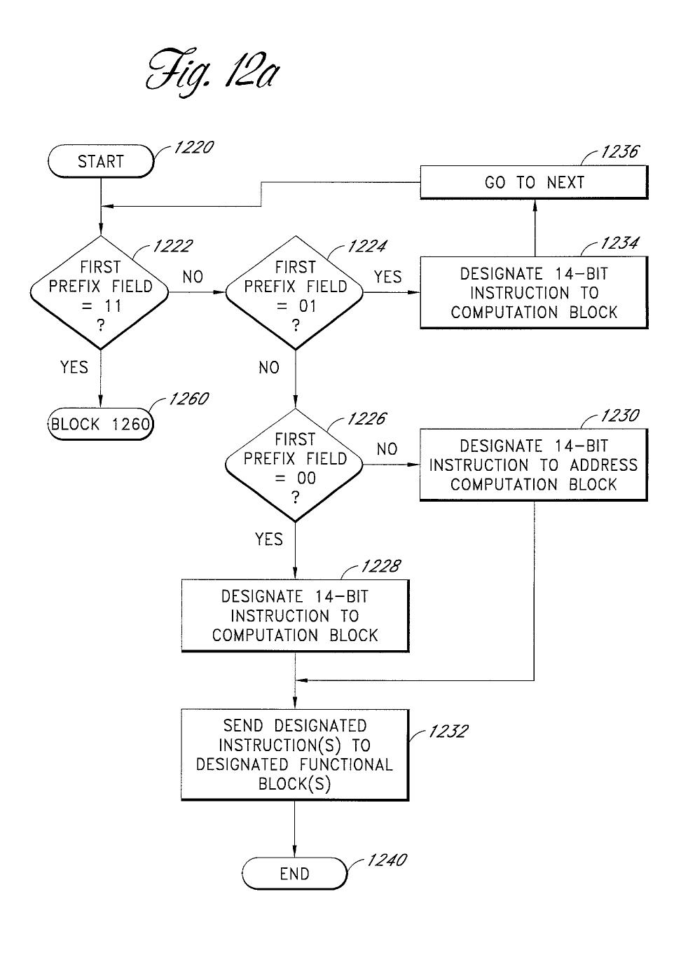

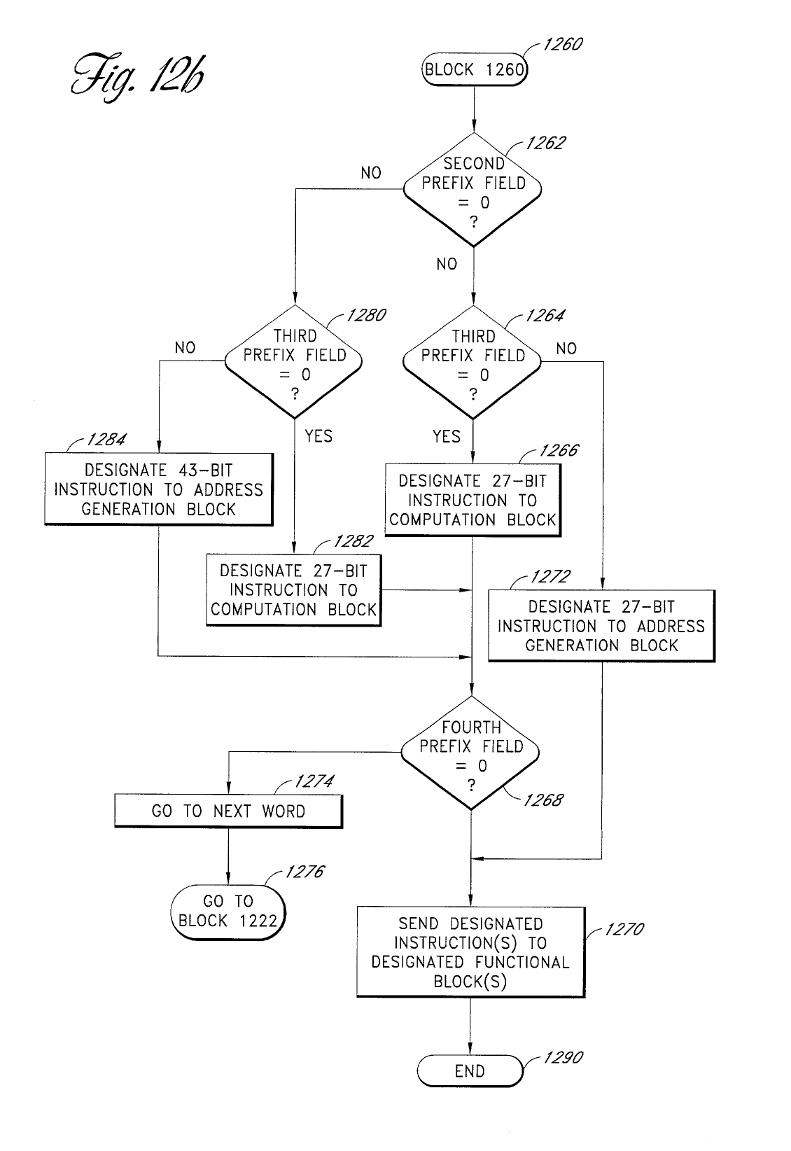

FIG. 11A is a flowchart showing one embodiment of the process of dispatching an execute packet with the instruction format of FIG. 6A. From a start block 1120 of FIG. 11A, the process proceeds to a decision block 1122 to analyze an execute packet which is fetched from program memory 150 to the dispatcher 242. At the decision block 1122, the dispatcher 242 determines if the value of the first prefix field 602 is 00. If the first prefix field 602 is 00, indicating that the execute packet does not include a computation block instruction, then the process jumps forward to a block 1140; otherwise, the process proceeds to a decision block 1124.

At the decision block 1124, if the first prefix field 602 is 01, then the process proceeds to a block 1126; otherwise, the process proceeds to a decision block 1128. At the block 1126, the dispatcher 242 designates the first 16 bits following the prefix fields 602 and 604 as a 16-bit instruction to the computation block 220. The process then proceeds from the block 1126 to the block 1140.

At the decision block 1128, if the first prefix field 602 is 10, then the process proceeds to a block 1130; otherwise, the process proceeds to a block 1132. At the block 1130, the dispatcher 242 designates the first 32 bits following the prefix fields 602 and 604 as a 32-bit instruction to the computation block 220. The process then proceeds from the block 1130 to the block 1140.

At the block 1132, since the first prefix field 602 is not 00, 01 or 10 (indicating a value of 11), the dispatcher 242 designates the first 48 bits following the prefix fields 602 and 604 as a 48-bit instruction to the computation block 220. The process then proceeds to the block 1140.

FIG. 11B is a flowchart showing one embodiment of the process of dispatching an execute packet, as a continuation of FIG. 11A, starting from the block 1140. From block 1140 the process proceeds to a decision block 1142. At the decision block 1142, if the second prefix field 604 is 00, then the process jumps to a block 1154; otherwise, the process proceeds to a decision block 1144. At the decision block 1144, if the second prefix field 604 is 01, then the process proceeds to a block 1146; otherwise, the process proceeds to a decision block 1148.

At the block 1146, the dispatcher 242 designates the next 16 bits as a 16-bit instruction to the address generation block 210. The process then proceeds to the block 1154. At the decision block 1148, if the second prefix field 604 is 10, then the process proceeds to a block 1150; otherwise, the process proceeds to a block 1152.

At the block 1150, the dispatcher 242 designates the next 32 bits as a 32-bit instruction to the address generation block 210. The process then proceeds to the block 1154. At the block 1152, if the second prefix field 604 is not 00, 01 or 10 (indicating a value of 11), then the dispatcher 242 designates the next 48 bits as a 48-bit instruction to the address generation block 210. The process then proceeds to the block 1154, where the dispatcher 242 sends designated instructions to their designated destination functional block. The process then proceeds to an end block 1156.

In one embodiment of the block 1154, the dispatcher 242 sends the first prefix field 602 and a designated instruction to the computation block 220, and sends the second prefix field 604 and a designated instruction to the address generation block 210. The prefix field 602 or 604 is sent to the destination functional block, in order for an instruction decoder 214 or 230 to identify the length of the instruction.

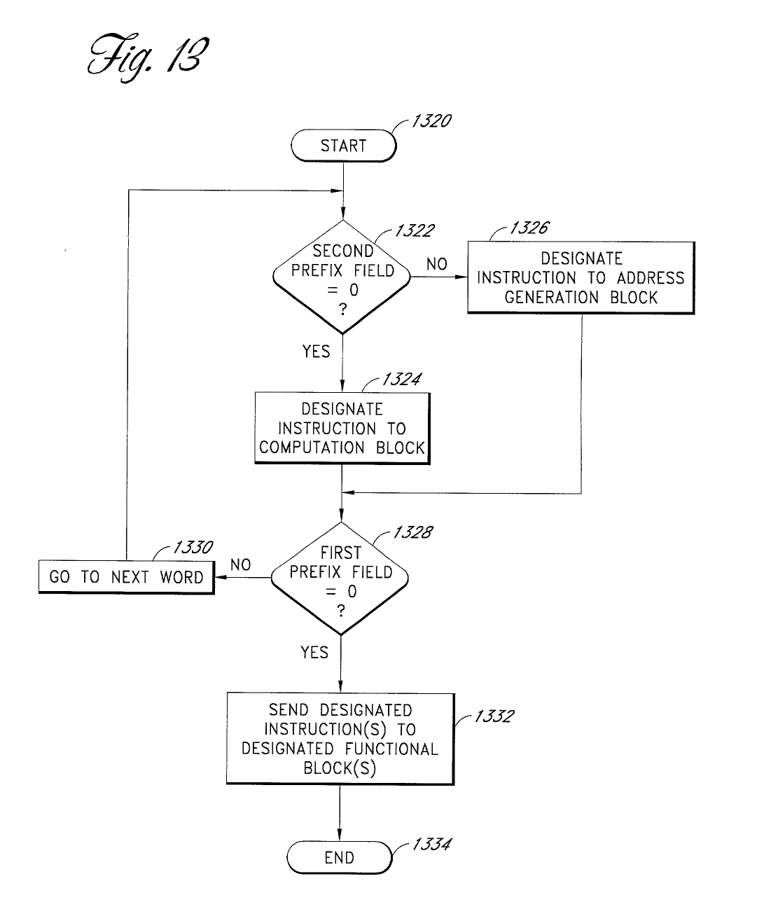

FIG. 12A is a flowchart showing one embodiment of the process of dispatching an execute packet with the instruction format of FIG. 7A. From a start block 1220, the process proceeds to a decision block 1222 to analyze an execute packet which is fetched from the program memory 150 to the dispatcher 242. An execution packet can contain one or more instruction words of the format illustrated in FIG. 7A. At the decision block 1222 of FIG. 12A, the dispatcher 242 determines if the value of the first prefix field 702 is 11. If the first prefix field 702 is 11, then the first instruction unit of the current execute packet is a 32 or 48 bit instruction unit, and the process proceeds to block 1260, which is illustrated in FIG. 12B; otherwise, the process proceeds to a decision block 1224.

At the decision block 1224, if the first prefix field 702 is 01, then the current 16-bit instruction unit is followed by another instruction unit having an address generation block instruction and the process proceeds to a block 1234; otherwise, the process proceeds to a decision block 1226.

At the block 1234, the dispatcher designates the 14-bit instruction in the instruction field of the current 16-bit instruction unit to the destination of the computation block 220. The process then proceeds to a block 1236. At the block 1236, the dispatcher proceeds to analyze the next word in the current execute packet. From the block 1236, the process returns to the block 1222 to analyze the new word.

At the decision block 1226, the dispatcher 242 determines if the first prefix field 702 is 00. If the first prefix field 702 is 00, then the process proceeds to a block 1228; otherwise, the process proceeds to a block 1230. At the block 1228, the dispatcher designates the 14-bit instruction in the instruction field of the current instruction unit to the computation block 220. The process then proceeds from the block 1228 to a block 1232. At the block 1230, the dispatcher designates the 14-bit instruction in the instruction field of the current instruction unit to the address generation block 210. The process proceeds from the block 1230 proceeds to the block 1232. At the block 1232, the dispatcher 242 sends designated instructions to their respective designated functional blocks. The process proceeds from the block 1232 proceeds to an end block 1240.

FIG. 12B is a flowchart showing one embodiment of the process of dispatching an execute packet, as a continuation of FIG. 12A, starting from the block 1260. As described above, the block 1260 is reached when the current instruction unit is a 32 or 48 bit instruction unit. The process proceeds from the block 1260 to a decision block 1262. At the decision block 1262, the dispatcher 242 determines if the second prefix field 704 is 0. If the second prefix field 704 is 0, then the process proceeds to a decision block 1264. Otherwise the process proceeds to a decision block 1280.

At the decision block 1264, the dispatcher determines if the third prefix field 706 is 0. If the third prefix field 706 is 0, then the process proceeds to a block 1266; otherwise, the process proceeds to a block 1272. At the block 1266, the dispatcher designates the 27-bit instruction to the computation block 220. The process proceeds from the block 1266 to a decision block 1268.

At the block 1272 (indicating that the third prefix field 706 is 1), the dispatcher 242 designates the 27-bit instruction (or in another embodiment, the 28-bit instruction with the unused fourth prefix field 708 becoming part of the instruction field 710) to the address generation block 210. The process then proceeds from the block 1272 to a block 1270.

At the decision block 1280, if the third prefix field 706 is 0, then the process proceeds to a block 1282; otherwise, the process proceeds to a block 1284. At the block 1282, the dispatcher 242 designates the 43-bit instruction to the computation block 220. The process proceeds from the block 1282 to the decision block 1268. At the block 1284, the dispatcher 242 designates the 43-bit instruction (or in another embodiment, the 44-bit instruction with the unused fourth prefix field 708 becoming part of the instruction field 710) to the address generation block 210. The process proceeds from the block 1284 to the block 1270.

At the decision block 1268, the dispatcher 242 determines if the fourth prefix field 708 is 0. If the fourth prefix field 708 is 0, then the process proceeds to the block 1270; otherwise, the process proceeds to a block 1274. At the block 1270, the dispatcher 242 sends designated instructions to their respective destination functional block. Block 1270 proceeds to an end block 1290. At the block 1274 (indicating that the fourth prefix field 708 is 1), the dispatcher 242 proceeds to analyze the next word in the current execute packet. The process proceeds from the block 1274 to a block 1276, which returns to the block 1222 of FIG. 12A.

In one embodiment of block 1232 of FIG. 12A and block 1270 of FIG. 12B, for each designated instruction, the dispatcher 242 sends the first prefix field 702, the second prefix field 704 and the designated instruction to the destination functional block. The prefix fields 702 and 704 are sent to the destination functional block, in order for an instruction decoder 214 or 230 to identify the length of the instruction. The instruction decoder 214 or 230 identifies an instruction length of 14 bits when the first prefix field 702 is 00, 01 or 10. The instruction decoder 214 or 230 identifies an instruction length of 27 bits when the first prefix field 702 is 11 and the second prefix field 704 is 0. The instruction decoder 214 or 230 identifies an instruction length of 43 bits when the first prefix field 702 is 11 and the second prefix field 704 is 1. In another embodiment, instead of the first prefix field 702 and the second prefix field 704, the dispatcher 242 sends a new prefix field and the designated instruction to its functional block. The new prefix field is a 2-bit field capable of indicating instruction length possibilities of 14 bits, 27 bits, and 43 bits.

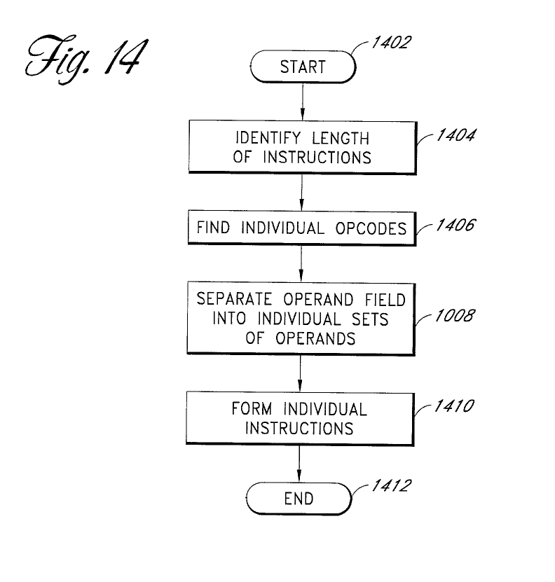

FIG. 13 is a flowchart showing one embodiment of the process of dispatching an execute packet with the instruction format of FIG. 8A. From a start block 1320, the process proceeds to a decision block 1322 to analyze an execute packet that is fetched from program memory to the dispatcher 242. An execution packet can contain one or more instruction words of the format illustrated in FIG. 8A. At the decision block 1322 of FIG. 13, the dispatcher 242 determines if the value of the second prefix field 804 is 0. If the second prefix field 804 is 0, then the process proceeds to a block 1324; otherwise, the process proceeds to a block 1326.

At the block 1324, the dispatcher 242 designates the 14-bit instruction in the 14-bit instruction field of the first 16-bit word to the computation block 220. The process then proceeds to a decision block 1328. At the block 1326, the dispatcher designates the 14-bit instruction in the 14-bit instruction field of the first 16-bit word to the address generation block 210. The process proceeds from the block 1326 to the decision block 1328.

At the decision block 1328, the dispatcher 242 determines if the value of the first prefix field 802 is 0. If the first prefix field 802 is 0, then the dispatcher 242 recognizes that the current execute packet contains only one 16-bit word, and proceeds to block 1332 to complete the dispatching of the current execute packet; otherwise, the process proceeds to a block 1330. At block 1332, the dispatcher 242 sends the designated instruction(s) of all words in the current execute packet to their respective designated functional block. The process proceeds from the block 1332 proceeds to an end block 1334.

At the block 1330, which indicates that the current execute packet contains at least another 16-bit word, the dispatcher 242 starts analyzing the next 16-bit word of the current execute packet. From the block 1330, the process jumps back to block 1322 to analyze the prefix fields of the next 16-bit word.

In one embodiment of block 1332, for each designated instruction, the dispatcher 242 sends a new prefix field and the designated instruction to the destination functional block. The new prefix field is a 2-bit field capable of indicating instruction length possibilities of 14 bits, 28 bits, and 42 bits. When the destination functional block receives a sent instruction, the instruction decoder 214 or 230 uses the new prefix field to identify the length of the instruction.

An instruction is sent by the dispatcher 242 to its destination functional block. Depending on its destination (e.g., the computation block 220 or the address generation block 210), it is then decoded by the address generation block decoder 214 or the computation block decoder 230. The decoder reads the opcode and sends the instruction to the appropriate functional unit within the functional block to be executed. If the opcode is a combination opcode indicating a combination of individual instructions, then the decoder separates the instruction into the individual instructions and sends each of the individual instructions to its appropriate functional unit to be executed.

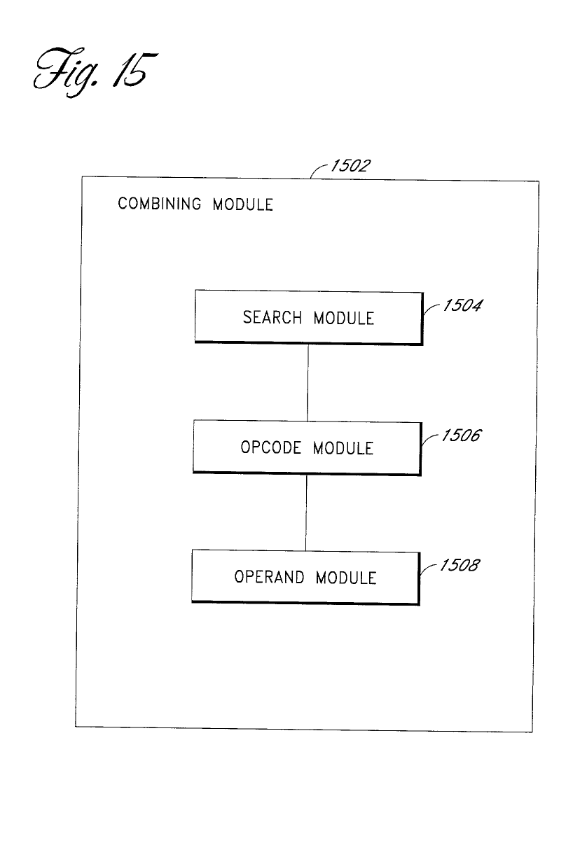

FIG. 14 is a flowchart showing one embodiment of a decoding process. This section describes the decoding of a combined instruction in connection with FIG. 14, although an individual instruction may also be decoded using this process. From a start block 1402, the process in FIG. 14 proceeds to a block 1404. At the block 1404, the decoder identifies the length of the instruction by reading a prefix field value. In one embodiment related to FIGS. 6A, 11A and 11B, the prefix field is a 2-bit field indicating possible lengths of 16 bits, 32 bits or 48 bits. In another embodiment related to FIGS. 7A, 12A and 12B, the prefix field is a 2-bit field indicating possible lengths of 14 bits, 27 bits or 43 bits. In yet another embodiment related to FIGS. 8A and 13, the prefix field is a 2-bit field indicating possible lengths of 14 bits, 28 bits or 42 bits.

In one embodiment, a functional block includes three decoders for decoding instructions of no more than 16 bits, instructions of more than 16 and no more than 32 bits, and instructions of more than 32 bits, respectively. Based on the identified length of the instruction, the instruction is sent to one of the three decoders for decoding. In another embodiment described in connection with FIG. 14, a functional block includes one decoder for decoding instructions of all lengths.

After the block 1404, the process proceeds to a block 1406. At the block 1406, the decoder reads the combination opcode from an opcode field of the combined instruction, and finds an instruction combination in table 902 that corresponds to the combination opcode. The instruction combination in table 902 is preferably in the form of a combination of the opcodes of the individual instructions. The process then proceeds to a block 1408. At the block 1408, the decoder separates the operand field of the combined instruction into individual sets of operands, with each individual set of operands corresponding to one individual instruction. In one embodiment, after the decoder has identified the combination of individual instructions, the decoder infers the length and number of operands of each individual instruction. The decoder then separates the operand field of the combined instruction into individual sets of operands. In another embodiment, the decoder reads one or more prefix field value stored in the combined instruction. The prefix field values are indicators that distinguish individual sets of operands from each other, such as the starting position and/or length of individual sets of operands within the operand field.

The process then proceeds to a block 1410. At the block 1410, for each individual instruction, the decoder combines its individual opcode and its individual set of operands to form the individual instruction. In one embodiment, the decoder can then perform additional decoding on the individual instruction, such as fetching operands from memory. (Rehan, Hassan: Is this correct?) The decoder then sends the individual instruction to its destination functional unit for execution. The destination functional unit may be identified by the decoder from the opcode of the individual instruction. The process then proceeds to an end block 1412.

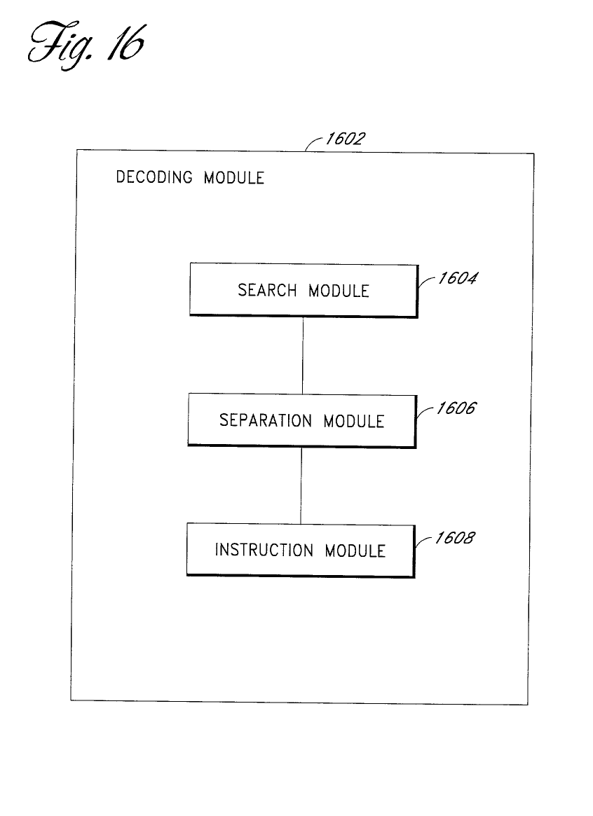

FIG. 15 is a block diagram showing one embodiment of a combining module 1502 for combining individual instructions into a combined instruction. The combining module 1502 includes a search module 1504, an opcode module 1506, and an operand module 1508. The modules 1502, 1504, 1506, and 1508 can be implemented as computer instructions in hardware, software, firmware, or any combinations of the above. From the table 902, the search module 1504 obtains a combination opcode that corresponds to a combination of the individual instructions. The opcode module 1506 assigns the obtained combination opcode to an opcode field of the combined instruction. The operand module 1508 combines the operands of the individual instructions into a combined set of operands, and assigns the combined set of operands into an operand field of the combined instruction. In one embodiment, the operand module 1508 also stores one or more indicators in the combined instruction, in order to distinguish the operands of individual instructions from each other.

In one embodiment, the combining module 1502 is included in a assembler or compiler program. The combining module 1502 combines multiple instructions that are to be executed by different functional units within the same function block starting at the same clock cycle. The combining module 1502 saves memory space by using a combination opcode to identify the combination of instructions. When the combined instruction is sent to the functional block, it is separated into individual instructions by a decoding module described in the next section.

FIG. 16 is a block diagram showing one embodiment of a decoding module 1602 for separating a combined instruction into multiple individual instructions. The decoding module 1602 includes a search module 1604, a separation module 1606, and an instruction module 1608. The modules 1602, 1604, 1606, and 1608 can be implemented as computer instructions in hardware, software, firmware, or any combinations of the above. From the table 902, the search module 1604 finds an instruction combination that corresponds to the combination opcode of the combined instruction. In one embodiment, the found instruction combination includes a list of individual opcodes of the individual instructions that form the combination.

The separation module 1606 separates the combined set of operands of the combined instruction into multiple sets of operands, with each set of operands being the set of operands for a individual instruction. In one embodiment, the separation module 1606 uses indicators stored in the combined instruction to distinguish the operands of one individual instruction from the operands of another individual instruction. In another embodiment, since search module 1604 has identified the individual instructions that form the combination, the separation module 1606 is able to infer the number and length of operands for each individual instruction.

For each individual instruction, the instruction module 1608 combines its opcode and its set of operands to form the individual instruction. In one embodiment, the decoding module 1602 also includes a sending module (not shown) that sends each individual instruction to its destination functional unit for execution.

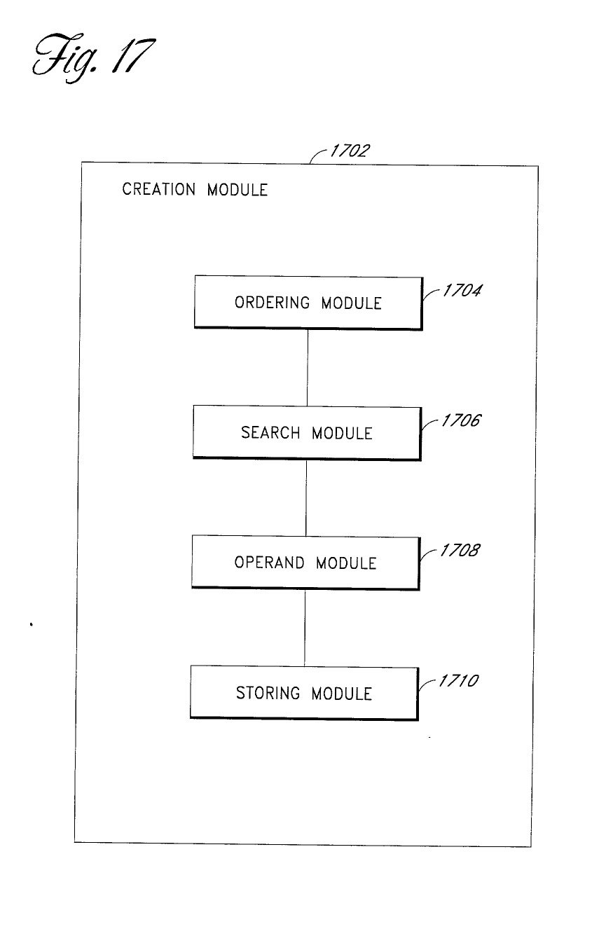

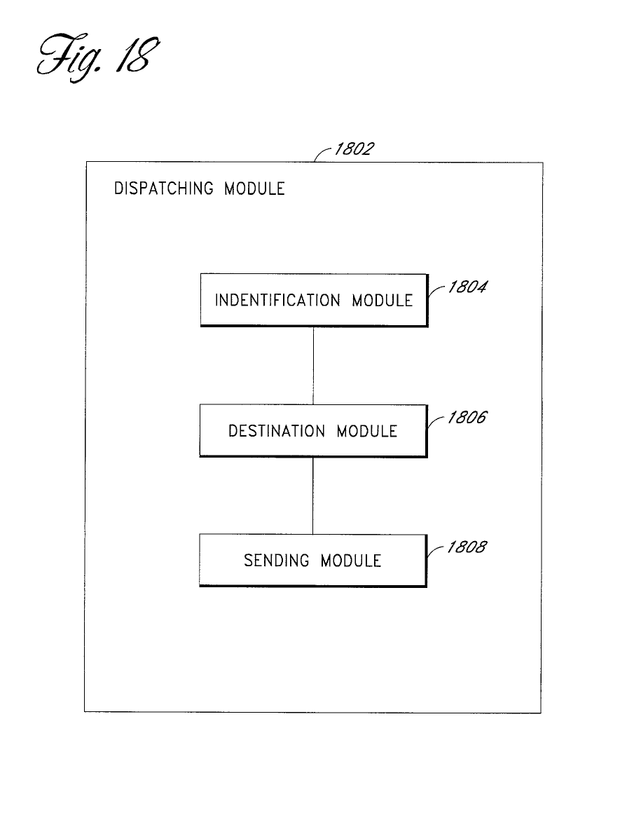

FIG. 17 illustrates one embodiment of a creation module 1702 for creating an execute packet. The creation module 1702 includes ordering module 1704, search module 1706, operand module 1708, and storing module 1710. The modules 1702, 1704, 1706, 1708, and 1710 can be implemented as computer instructions in hardware, software, firmware, or any combinations of the above. The ordering module 1704 orders multiple individual instructions into subsets according to their destination functional block. Each subset of instructions share the same destination functional block. For each subset of instructions, the search module 1706 obtains from the table 902 a combination opcode that corresponds to a combination of that subset of instructions. For each subset of instructions, the operand module 1708 combines the operands of the subset of instructions into a combined set of operands. In one embodiment, the operand module 1708 combines the operands by appending the operands of every other instruction in the subset to the operands of the first instruction in the subset. For each subset of instructions, the storing module 1710 stores its combination opcode and its combined set of operands into an instruction block of the execute packet.

In one embodiment, the creation module 1702 is included in a assembler or compiler program. In one embodiment, the creation module 1702 includes the combination module 1502. After instructions are ordered into subsets by the ordering module 1704, the combination module 1502 is applied to every subset of instructions to combine the instructions within a subset into a combined instruction.

In embodiments described in connection with FIGS. 6A, 7A, and 8A, prefix fields such as field 602 and field 604 for FIG. 6A, prefix fields 702, 704, 706 and 708 for FIG. 7A, and prefix field 802 and field 804 for FIG. 8A are added to the execute packet by the storing module 1710. For example, if the instruction format of FIG. 6A is used, the storing module 1710 stores a first prefix field 602 and a second prefix field 604 in the execute packet. The first prefix field 602 indicates the length of the first instruction block, the second prefix field 604 indicates the length of the second instruction block. Additional prefix fields can be stored if there are more than two subsets of instructions and therefore more than two instruction blocks within the execute packet.

FIG. 18 illustrates one embodiment of a dispatching module 1802 for dispatching an execute packet. The dispatching module 1802 includes an identification module 1804, a destination module 1806, and a sending module 1808. The modules 1802, 1804, 1806, and 1808 can be implemented as computer instructions in hardware, software, firmware, or any combinations of the above. The identification module 1804 identifies instruction blocks within the execute packet, with each instruction block representing a (combined or individual) instruction having a unique destination functional block. The identification module 1804 can use one or more indicators within the execute packet to distinguish one instruction block from another. For example, given an execute packet of the instruction format of FIG. 6A, the identification module 1804 uses the first prefix field 602 and the second prefix field 604 to identify the instruction blocks.

The destination module 1806 identifies the destination functional block of each instruction block identified by the identification module 1804. The destination module 1806 can use one or more indicators within the execute packet to identify the destination functional block of each instruction block. For example, given an execute packet of the instruction format of FIG. 6A, the destination module 1806 uses the first prefix field 602 and the second prefix field 604 to identify the destination functional blocks. The sending module 1808 sends each instruction block to its destination functional block. In one embodiment, the dispatching module 1802 is located within the dispatcher 242.

Although this invention has been described in terms of certain embodiments, other embodiments that are apparent to those of ordinary skill in the art are also within the scope of this invention. For example, although the embodiments described herein use the protocol that a computation block instruction precedes an address generation block instruction in an execute packet, the ordering of these two types of instructions can be reversed in alternative embodiments. Although the above-described embodiments focus on 16-bit words and 16, 32 and 48 bit instruction units, words and instruction units of other lengths may also be embodied. Accordingly, the scope of the present invention is to be defined by reference to the following claims.

What is claimed is:

1. A method of combining a first microprocessor instruction and a second microprocessor instruction into a combined instruction, the first instruction having a first opcode and a first set of operands, the second instruction having a second opcode and a second set of operands, the first opcode being executable by a first functional unit and the second opcode being executable by a second functional unit, the method comprising:
obtaining from a combination opcode table a combination opcode that corresponds to a combination of the first opcode and the second opcode, the combination opcode table having one-to-one correspondences of a set of combination opcodes and a set of opcode combinations, each of the set of opcode combinations being a combination of opcodes executable by different functional units;
assigning the found combination opcode to an opcode field of the combined instruction;
combining the first set of operands and the second set of operands into a combined set of operands; and
assigning the combined set of operands to an operand field of the combined instruction.

2. The method of claim 1, wherein the method is performed by a compiler.

3. The method of claim 1, wherein the method is performed by an assembler.

4. The method of claim 1, wherein the first instruction and the second instruction are to be executed starting at a single microprocessor clock cycle.

5. The method of claim 1, wherein combining the first set of operands and the second set of operands comprises appending the second set of operands to the first set of operands.

6. The method of claim 5, further comprising adding a prefix value to the combined instruction, the prefix value indicating a starting position of the second set of operands within the combined instruction.

7. The method of claim 5, further comprising adding a prefix value to the combined instruction, the prefix value indicating a length of the first set of operands within the combined instruction.

8. The method of claim 1, wherein the first functional unit and the second functional unit are located within a single functional block.

9. A method of separating a combined instruction into a first microprocessor instruction and a second microprocessor instruction, the combined instruction having a combination opcode and a combined set of operands, the method comprising:
obtaining from a combination opcode table a first opcode and a second opcode that correspond to the combination opcode, the combination opcode table having one-to-one correspondences of a set of combination opcodes and a set of opcode combinations;
separating the combined set of operands into a first set of operands and a second set of operands;
combining the first opcode and the first set of operands into the first instruction; and
combining the second opcode and the second set of operands into the second instruction.

10. The method of claim 9, wherein the method is performed by an instruction decoder.

11. The method of claim 9, further comprising:
sending the first instruction to a first functional unit for execution; and
sending the second instruction to a second functional unit for execution.

12. The method of claim 11, wherein the execution of the first instruction and the execution of the second instruction start in a single microprocessor clock cycle.

13. The method of claim 11, wherein the first functional unit and the second functional unit are located within a single functional block.

14. The method of claim 9, wherein separating the combined set of operands comprises inferring from the first opcode a length of the first set of operands.

15. The method of claim 9, wherein separating the combined set of operands comprises:
reading a prefix value that indicates a starting position of the second set of operands within the combined set of operands; and
separating the combined set of operands into the first set of operands and the second set of operands, using the starting position indicated by the prefix value.

16. The method of claim 9, wherein separating the combined set of operands comprises:
from the combined instruction, reading a prefix value that indicates a length of the first set of operands within the combined set of operands; and
separating the combined set of operands into the first set of operands and the second set of operands, using the length indicated by the prefix value.

17. A data structure in a computer-readable form for storing a first microprocessor instruction and a second microprocessor instruction, the data structure comprising:
a combination opcode field for storing a combination opcode, the combination opcode being a code that identifies a first opcode-second opcode combination, the first opcode and the second opcode being respective opcodes of the first instruction and the second instruction, the first instruction and the second instruction being executable by different functional units, and
an operand field for storing a combined set of operands, the combined set of operands being a combination of a first set of operands of the first instruction and a second set of operands of the second instruction.

18. The data structure of claim 17, further comprising a prefix field for storing a prefix value, the prefix value indicating a starting position of the second set of operands within the operand field.

19. The data structure of claim 17, further comprising a prefix field for storing a prefix value, the prefix value indicating a length of the first set of operands within the operand field.

20. A data structure in a computer-readable form for storing a set of combination opcodes and a set of corresponding opcode combinations, comprising:
a combination opcode field for storing a combination opcode; and
an opcode combination field for storing a combination of individual opcodes, the individual opcodes being respective opcodes of individual instructions, the individual instructions being executable by different functional units.

21. The data structure of claim 20, wherein the combination opcode field has a fixed length.

22. The data structure of claim 20, wherein the combination opcode field has a variable length.

23. A data structure in a computer-readable form for storing microprocessor instructions, the data structure comprising:
an instruction field for storing a fist instruction and a second instruction, the first instruction having a destination of a first functional block, the second instruction having a destination of a second functional block; and
an prefix field for storing a first indicator and a second indicator, the first indicator indicating a length of the first instruction, the second indicator indicating a length of the second instruction.

24. The data structure of claim 23, wherein the first instruction comprises a combination opcode and a combined set of operands, the combination opcode identifying a combination of a third opcode and a fourth opcode, the combined set of operands including a third set of operands and a fourth set of operands, the third and fourth opcodes being respective opcodes of a third and a fourth instruction, the third and fourth sets of operands being respective sets of operands of the third and the fourth instruction, the third and fourth instructions being executable by different functional units within the first functional block.

25. The data structure of claim 23, wherein the first instruction and the second instruction are to be executed starting at a single clock cycle.

26. A method of creating an execute packet in a computer-readable form, the execute packet including microprocessor instructions to be executed starting at a particular clock cycle, the method comprising:
identifying a first length of a first instruction, the first instruction having a destination of a first functional block;
identifying a second length of a second instruction, the second instruction having a destination of a second functional block;
storing a first indicator for the first length in a prefix field of the execute packet;
storing a second indicator for the second length in the prefix field of the execute packet;
storing the first instruction in an instruction field of the execute packet; and
storing the second instruction in the instruction field of the execute packet.

27. The method of claim 26, wherein the method is performed by a compiler.

28. The method of claim 26, wherein the method is performed by an assembler.

29. The method of claim 26, further comprising:
combining a third instruction and a fourth instruction into the first instruction prior to identifying the first length of the first instruction, the third instruction and the fourth instruction being executable by different functional units within the first functional block, the third instruction and the fourth instruction having respective opcodes of a third opcode and a fourth opcode, the third instruction and the fourth instruction having respective sets of operands of a third set of operands and a fourth set of operands.

30. The method of claim 29, wherein combining the third instruction and the fourth instruction into the first instruction comprises:
obtaining a combination opcode for a combination of the third opcode and the fourth opcode;
combining the third set of operands and the fourth set of operands into a combined set of operands; and
combining the combination opcode and the combined set of operands into the first instruction.

31. The method of claim 29, wherein combining the third instruction and the fourth instruction into the first instruction comprises:
retrieving from a table a combination opcode that corresponds to a combination of the third opcode and the fourth opcode, the table having one-to-one correspondences of combination opcodes and opcode combinations;
combining the third set of operands and the fourth set of operands into a combined set of operands; and
combining the combination opcode and the combined set of operands into the first instruction.

32. A method of dispatching an execute packet, the execute packet including microprocessor instructions to be executed starting at a particular clock cycle, the method comprising:
identifying a first indicator, the first indicator indicating a first length of a first instruction;
identifying a second indicator, the second indicator indicating a second length of a second instruction;
identifying the first instruction based on the identified first indicator;
identifying the second instruction based on the identified first indicator and the identified second indicator;
sending the first instruction to a first functional block; and
sending the second instruction to a second functional block.

33. The method of claim 32, wherein the method is performed by a dispatcher.

34. The method of claim 32, wherein the method is performed by a dispatcher located within a program sequencer.

35. The method of claim 32, further comprising:
identifying within the first functional block a combination opcode of the sent first instruction;
identifying within the first functional block a third opcode and a fourth opcode combination that corresponds to the identified combination opcode;
separating within the first functional block a combined set of operands of the first instruction into a third set of operands and a fourth set of operands;
combining within the first functional block the third opcode and the third set of operands into a third instruction;
combining within the first functional block the fourth opcode and the fourth set of operands into a fourth instruction;
sending the third instruction to a third functional unit within the first functional block for execution; and
sending the fourth instruction to a fourth functional unit within the first functional block for execution.

36. The method of claim 35, wherein the identifying a combination opcode, the identifying a third opcode and a fourth opcode, the separating a combined set of operands, the combining the third opcode and the third set of operands, the combining the fourth opcode and the fourth set of operands, the sending the third instruction, and the sending the fourth instruction are performed by an instruction decoder within the first functional block.

37. A data structure in a computer-readable form for storing microprocessor instructions, the data structure comprising:
a first instruction field for storing a fist instruction, the first instruction having a destination of a first functional block;
a second instruction field for storing a second instruction, the second instruction having a destination of a second functional block;
a first prefix field for storing a first indicator, the first indicator indicating a length of the first instruction; and
a second prefix field for storing a second indicator, the second indicator indicating a length of the second instruction.

38. A method of creating an execute packet in a computer-readable form, the execute packet including microprocessor instructions to be executed starting at a particular clock cycle, the method comprising:
identifying a first length of a first instruction, the first instruction having a destination of a first functional block;
identifying a second length of a second instruction, the second instruction having a destination of a second functional block;
storing a first indicator for the first length in a first prefix field of the execute packet;
storing a second indicator for the second length in a second prefix field of the execute packet;
storing the first instruction in a first instruction field of the execute packet; and
storing the second instruction in a second instruction field of the execute packet.

39. The method of claim 38, further comprising:
combining a third instruction and a fourth instruction into the first instruction prior to identifying the first length, the third instruction and the fourth instruction being executable by different functional units within the first functional block, the third instruction and the fourth instruction having respective opcodes of a third opcode and a fourth opcode, the third instruction and the fourth instruction having respective sets of operands of a third set of operands and a fourth set of operands.

40. The method of claim 39, wherein combining the third instruction and the fourth instruction into the first instruction comprises:
obtaining a combination opcode for a combination of the third opcode and the fourth opcode;
combining the third set of operands and the fourth set of operands into a combined set of operands; and
combining the combination opcode and the combined set of operands into the first instruction.

41. The method of claim 39, wherein combining the third instruction and the fourth instruction into the first instruction comprises:
retrieving from a table a combination opcode for a combination of the third opcode and the fourth opcode, the table having one-to-one correspondences of combination opcodes and opcode combinations;
combining the third set of operands and the fourth set of operands into a combined set of operands; and
combining the combination opcode and the combined set of operands into the first instruction.

42. An execute packet in a computer-readable form for storing microprocessor instructions to be executed starting at a particular clock cycle, the execute packet comprising one or more instruction words, each instruction word comprising:
a first prefix field for storing a first indicator indicating a length of an instruction;
a second prefix field for storing a second indicator indicating a destination functional block of the instruction; and
an instruction field for storing at least a portion of the instruction.

43. The execute packet of claim 42, wherein the instruction includes a combination opcode and a combined set of operands, the combination opcode corresponding to a combination of a first opcode and a second opcode, and the combined set of operands being a combination of a first set of operands and a second set of operands, the first opcode and the second opcode being respective opcodes of a first instruction and a second instruction, the first set of operands and a second set of operands being respective sets of operands of the first instruction and the second instruction.

44. A method of creating an execute packet in a computer-readable form, the execute packet including microprocessor instructions to be executed starting at a particular clock cycle, the method comprising:
from a set of microprocessor instructions, identifying a first subset of instructions having a destination of a first functional block, and a second subset of instructions having a destination of a second functional block;
obtaining a first combination opcode which identifies a combination of the first subset of instructions;
obtaining a second combination opcode which identifies a combination of the second subset of instructions;
combining a set of operands for each of the first subset of instructions into a first combined set of operands;
combining a set of operands for each of the second subset of instructions into a second combined set of operands;
storing the first combination opcode and the first combined set of operands in a first instruction block of the execute packet; and
storing the second combination opcode and the second combined set of operands in a second instruction block of the execute packet.

45. The method of claim 44, further comprising:
storing a first indicator which identifies the first functional block as a destination of the first instruction block; and
storing a second indicator which identifies the second functional block as a destination of the second instruction block.

46. The method of claim 44, wherein obtaining a first combination opcode comprises obtaining a first combination opcode from a table, the table having one-to-one correspondences of combination opcodes and combinations of instructions.

47. A method of decoding an instruction block in a computer-readable from within a functional block, the method comprising:
identifying a combination opcode of the instruction block;
identifying a first opcode and second opcode combination that corresponds to the identified combination opcode;
separating a combined set of operands of the instruction block into a first set of operands and a second set of operands;
combining the first opcode and the first set of operands into a first instruction;
combining the second opcode and the second set of operands into a second instruction;
sending the first instruction to a first functional unit within the functional block for execution; and
within a single clock cycle of sending the first instruction, sending the second instruction to a second functional unit within the functional block for execution.

48. The method of claim 47, wherein identifying a first opcode and second opcode combination comprises:
obtaining from a table a combination of the first opcode and the second opcode, the table having one-to-one correspondences of opcode combinations and combination opcodes, the combination corresponding to the identified combination opcode.

49. A combining module for combining a first microprocessor instruction and a second microprocessor instruction into a combined instruction, the first instruction having a first opcode and a first set of operands, the second instruction having a second opcode and a second set of operands, the first opcode being executable by a first functional unit and the second opcode being executable by a second functional unit, the combining module comprising:
a search module configured to obtain from a combination opcode table a combination opcode that corresponds to a combination of the first opcode and the second opcode, the combination opcode table having one-to-one correspondences of a set of combination opcodes and a set of opcode combinations;
an opcode module configured to assign the found combination opcode to an opcode field of the combined instruction; and
an operand module configured to combine the first set of operands and the second set of operands into a combined set of operands and further configured to assign the combined set of operands to an operand field of the combined instruction.

50. A decoding module for separating a combined instruction into a first microprocessor instruction and a second microprocessor instruction, the combined instruction having a combination opcode and a combined set of operands, the decoding module comprising:
a search module configured to obtain from a combination opcode table a first opcode-second opcode combination that corresponds to the combination opcode, the combination opcode table having one-to-one correspondences of a set of combination opcodes and a set of opcode combinations;
a separation module configured to separate the combined set of operands into a first set of operands and a second set of operands; and
an instruction module configured to combine the first opcode and the first set of operands into the first instruction and further configured to combine the second opcode and the second set of operands into the second instruction.

51. A creation module configured to create an execute packet in a computer-readable form, the execute packet including microprocessor instructions to be executed starting at a particular clock cycle, the creation module comprising:
an ordering module configured to identify from a set of instructions, a first subset of instructions whose destination is a first functional block, and a second subset of instructions whose destination is a second functional block;
a search module configured to obtain a first combination opcode which identifies a combination of the first subset of instructions, and a second combination opcode which identifies a combination of the second subset of instructions;
an operand module configured to combine a set of operands for each of the first subset of instructions into a first combined set of operands, and to combine a set of operands for each of the second subset of instructions into a second combined set of operands; and
a storing module configured to store the first combination opcode and the first combined set of operands in a first instruction block of the execute packet, and to store the second combination opcode and the second combined set of operands into a second instruction block of the execute packet.
